(19) United States
(12) Patent Application Publication
(10) Pub. No.: US 2004/0104525 A1
(43) Pub. Date: Jun. 3, 2004

(54) Sheet finisher with sheet folding capability and image forming system using the same

(76) Inventors: Nobuyoshi Suzuki, Tokyo (JP); Masahiro Tamura, Kanagawa (JP); Hiromoto Saitoh, Kanagawa (JP); Shuuya Nagasako, Tokyo (JP); Naohiro Kikkawa, Tokyo (JP); Hiroki Okada, Kanagawa (JP); Junichi Iida, Kanagawa (JP); Kenji Yamada, Tokyo (JP); Junichi Tokita, Kanagawa (JP); Akihito Andoh, Kanagawa (JP); Rika Andoh, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/640,044

(22) Filed: Aug. 14, 2003

(30) Foreign Application Priority Data
Aug. 14, 2002 (JP) 2002-236664 (JP)
Aug. 26, 2002 (JP) 2002-245195 (JP)
Oct. 31, 2002 (JP) 2002-318281 (JP)

(51) Int. Cl. B41L 43/00

(52) U.S. Cl. 270/32

(57) ABSTRACT

A sheet folding device for folding a sheet or a sheet stack conveyed thereto of the present invention includes a path along which the sheet or the sheet stack to be folded is conveyed. A fold plate is movable in a direction perpendicular to the above path for forming a fold in the sheet or the sheet stack. A pair of rotatable fold rollers face the fold plate and are positioned one above the other. Pressing members exerts, when the fold is to be formed, a pair of equal pressing forces on the fold rollers to thereby maintain the nip between the fold rollers on a line including the locus of movement of the fold plate.

### BACKGROUND OF THE INVENTION

1. Field of the Invention

The present invention relates to a sheet folding for folding a sheet or recording medium or a sheet stack carrying images thereon, a sheet finisher constructed integrally with or operatively connected to an image forming apparatus for sorting, stacking, stapling, center-stapling, folding or otherwise finishing the sheet or the sheet stack, and an image forming system consisting of the sheet finisher and image forming apparatus.

2. Description of the Background Art

A sheet finisher positioned at the downstream side of a copier, printer or similar image forming apparatus for stapling or otherwise finishing a sheet stack is well known in the art.

It is a common practice with a sheet finisher to staple a sheet stack at the center and then fold the sheet stack in two at the center. To fold the sheet stack, use is made of a fold plate configured to push the stapled portion of the sheet stack toward the nip of a pair of fold rollers while contacting the sheet stack substantially perpendicularly thereto. The sheet stack thus pushed is passed through the nip between the fold rollers and folded thereby. The prerequisite with such center stapling and center folding is that the sheet stack be folded by the fold roller pair at the position accurately coincident with the stapled position. A sheet stack so folded is attractive and can be smoothly spread.

To meet the above requisite, it has been proposed to press the two fold rollers with respective springs in such a manner as to maintain the nip between the rollers at the center of a folding position. Japanese Patent Laid-Open Publication Nos. 2000-143088 and 2000-211805, for example, each use a pair of fold rollers for folding the center of a sheet stack in the direction of conveyance and sheet pushing means including a push plate that pushes the fold of the sheet stack toward the nip between the fold rollers while moving toward the nip. The fold rollers are constantly biased toward each other by biasing means.

Before starting pressing the sheet stack, the fold rollers are held stationary at preselected positions by a stop member, which is fixed in place, while adjoining or lightly contacting each other so as not to exert excessive pressure. In this condition, the push plate is accurately moved toward the nip between the fold rollers to thereby accurately fold the sheet stack. Further, after the trailing edge of the sheet stack has moved away from the fold rollers, the fold rollers are prevented from hitting against each other.

However, in the configuration described above, the fold rollers adjoin or lightly contact each other only when a sheet stack is absent therebetween. When a sheet stack enters the nip between the fold rollers, the weight of the lower fold roller acts in a direction in which the force of the associated spring decreases while the weight of the upper fold roller acts in a direction in which the force of the associated spring increases. As a result, the pressing forces of the springs are brought out of balance with each other. Consequently, the lower fold roller is spaced from the pressing position more than the upper fold roller, so that the nip between the fold rollers is shifted from the center of the pressing position. This prevents the folded position of a sheet stack from accurately coinciding with the stapled position of the same and thereby makes the folded sheet stack unattractive.

Japanese Patent Laid-Open Publication No. 10-279177 discloses a sheet folding device configured to move, when a sheet stack is passed through a pair of fold rollers, one fold roller in unison with, but in the opposite direction to, the other fold roller. This, according to the above document, allows the center of a gap formed between the fold rollers to constantly coincide with the position of a line tangential to both of the rollers when the rollers contact each other. More specifically, a pair of swing arms respectively support the fold rollers at one end thereof and are swingable about respective fulcrums at the other end. A gear train or similar connecting means is arranged between the fulcrums to cause, when one of the swing arms swing, the other swing arm to swing in the opposite direction by the same angle. In this configuration, the fold rollers press a sheet stack while moving symmetrically to each other with respect to the center of a fold, so that the sheet stack can be folded at the same position as the stapled position.

However, a problem with the above sheet folding device is that the gear train or similar connecting means cannot be accurately positioned due to backlash and irregularity among parts. This not only makes it difficult to allow the folded position to accurately coincide with the stapled position, but also makes the resulting sheet stack unattractive.

Further, to sharply fold a sheet stack, it is generally necessary to increase the pressing force in accordance with the thickness of the sheet stack. However, the gear train or similar connecting means, used to move the fold rollers, is limited in strength, so that the pressing force of the fold roller pair must also be relatively weak. Consequently, the range over which the fold rollers can fold a sheet stack is limited. A sheet stack with a loose fold is not only unattractive as a bound matter, but also collapses when stacked together with the other sheet stacks.

Moreover, a fold roller pair, exerting a strong pressing force, is optimum in sharpening the fold of a sheet stack. However, when a sheet stack folded by such a fold roller pair is conveyed, the fold of the sheet stack again expands outward and again becomes loose because the innermost sheet is conveyed more than the outermost sheet little by little. In the worst case, the sheet stack is creased or broken. In addition, the fold rollers are apt to hit against each other when the trailing edge of the sheet stack moves away from the nip. The resulting impact is likely to damage the finisher while producing noise.

Technologies relating to the present invention are also disclosed in, e.g., Japanese Patent Laid-Open Publication No. 2000-211805.

### SUMMARY OF THE INVENTION

It is an object of the present invention to provide a sheet folding device capable of neatly, sharply folding a sheet or a sheet stack with fold rollers.

It is another object of the present invention to provide a sheet finisher capable of sharply folding a sheet stack, which is stapled at the center, with fold rollers while causing a folded position to accurately coincide with a stapled position, and allowing a plurality of such sheet stacks to be neatly stacked without collapsing.

It is a further object of the present invention to provide an image forming system consisting of the above sheet finisher and an image forming apparatus that outputs sheets carrying toner images thereon.

A sheet folding device for folding a sheet or a sheet stack conveyed thereto of the present invention includes a path along which the sheet or the sheet stack to be folded is conveyed. A fold plate is movable in a direction perpendicular to the above path for forming a fold in the sheet or the sheet stack. A pair of rotatable fold rollers face the fold plate and are positioned one above the other. Pressing members exerts, when the fold is to be formed, a pair of equal pressing forces on the fold rollers to thereby maintain the nip between the fold rollers on a line including the locus of movement of the fold plate.

### BRIEF DESCRIPTION OF THE DRAWINGS

The above and other objects, features and advantages of the present invention will become more apparent from the following detailed description taken with the accompanying drawings in which:

FIG. 1 is a view showing a first embodiment of the sheet folding device in accordance with the present invention;

FIG. 2 is a section along line X-X of FIG. 1;

FIG. 3 is a view showing a modification of the first embodiment;

FIG. 4 is a view showing another modification of the first embodiment;

FIG. 5 is a section along line Y-Y of FIG. 4;

FIG. 6 is a view showing a sheet finisher including any one of the first embodiment and modifications thereof;

FIGS. 7 through 35 are views for describing the construction and operation of the sheet finisher shown in FIG. 6;

FIG. 36 is a flowchart demonstrating a non-staple mode (a) available with the first embodiment;

FIG. 37 is a flowchart demonstrating a non-staple mode (b) available with the first embodiment;

FIG. 38 is a flowchart demonstrating a sort/stack mode available with the first embodiment;

FIGS. 39 through 41 are flowcharts demonstrating a staple mode available with the illustrative embodiment;

FIGS. 42 through 44 are flowcharts demonstrating a center staple mode available with the illustrative embodiment;

FIGS. 45 through 47 are views showing an image forming apparatus including the first embodiment;

FIG. 48 is a view showing a sheet finisher representative of a second embodiment of the present invention;

FIG. 49 is a view showing a drive mechanism for driving a fold roller pair included in the second embodiment;

FIG. 50 is a view showing a modification of the drive mechanism;

FIG. 51 is a view showing a sheet finisher representative of a third embodiment of the present invention;

FIG. 52 is a view showing fold rollers and a pressure applying and canceling mechanism included in the third embodiment in a pressure applying condition;

FIG. 53 is a view similar to FIG. 52, showing the fold rollers and pressure applying and canceling mechanism in a pressure canceling condition;

FIG. 54 is a flowchart demonstrating a center staple mode available with the third embodiment;

FIG. 55 is a view showing a first modification of the third embodiment in a pressure canceling condition;

FIGS. 56A and 56B are flowcharts demonstrating part of center staple mode operation available with the first modification of FIG. 55;

FIG. 57 is a flowchart demonstrating part of center staple mode operation representative of a second modification of the third embodiment;

FIG. 58 is a flowchart demonstrating part of center staple mode operation representative of a third modification of the third embodiment; and

FIG. 59 is a view showing a sheet finisher different from the sheet finishers of FIGS. 6, 48 and 51 and to which the present invention is similarly applicable.

### DESCRIPTION OF THE PREFERRED EMBODIMENTS

Preferred embodiments of the present invention will be described hereinafter. It is to be noted that the reference numerals used in each embodiment are independent of the reference numerals of the other embodiments, i.e., the same reference numerals do not always designate the same structural elements.

### First Embodiment

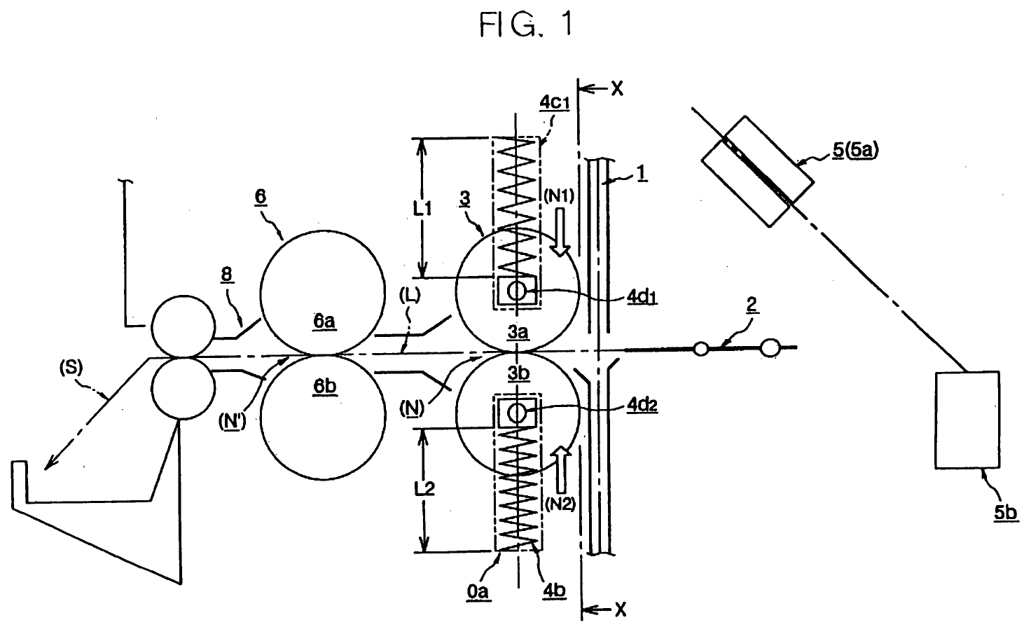

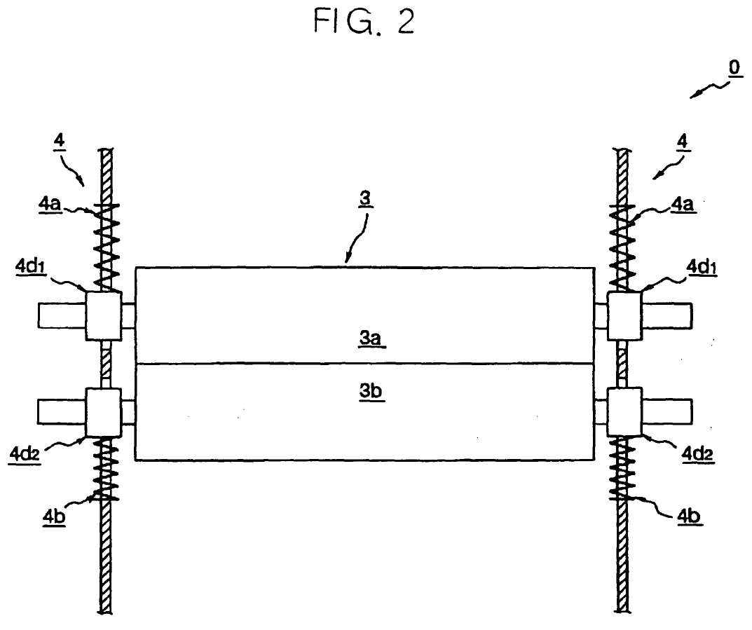

Referring to FIGS. 1 and 2 of the drawings, a sheet folding device embodying the present invention is shown and generally designated by the reference numeral 0. As shown, the sheet folding device 0 includes a path 1 along which a sheet S or a sheet stack S, stapled at the center by a center stapler 5a or stapled at one edge by an edge stapler 5b, is conveyed. The center stapler 5a and edge stapler 5b belong to binding means 5. A fold plate 2 is movable substantially perpendicularly to the path 1 for folding the sheet S or the sheet stack S. A pair of rotatable fold rollers 3a and 3b are positioned one above the other to face the fold plate 2 and are movable into and out of contact with each other in the up-and-down direction. Pressing means 4 includes upper pressing means 4a and lower pressing means 4b for exerting a pair of equal pressing forces on the fold rollers 3a and 3b, respectively, when the sheet or the sheet stack S is to be folded. With this configuration, the pressing means maintains a nip N between the fold rollers 3a and 3b on a line L including the locus of movement of the fold plate 2.

The fold rollers 3a and 3b can easily fold the sheet S or the sheet stack S at an accurate position. The resulting fold of the sheet S or the sheet stack S is sharp and neat, so that a plurality of sheet or sheet stacks can be sequentially stacked without collapsing. An upper bearing 4d1 and a lower bearing 4d2, collectively 4d, are movably received in an upper and a lower guide hole 4c1 and 4c2, respectively, which are formed in opposite side walls, not shown, of a device body 0a. The upper and lower fold rollers 3a and 3b are movably supported by the upper and lower bearings 4d1 and 4d2, respectively. The pressing means 4a and 4b, which are implemented by durable, low cost, easily adjustable springs, press the fold rollers 3a and 3b against each other in such a manner as to maintain the nip N on the line L.

In the above configuration, the fold rollers 3a and 3b exert pressing forces N1 and N2, respectively, which are expressed as:

N1=(free length of spring 4a−loaded length L1)×spring constant K1+weight of roller 3a

N2=(free length of spring 4b−loaded length L2)×spring constant K2+weight of roller 3b

The loaded lengths L1 and L2 are selected such that the spring constants K1 and K2 are equal to each other and such that the pressing forces N1 and N2 are equal to each other.

The fold rollers 3a and 3b move, even when conveying the sheet S or the sheet stack S, upward or downward symmetrically to each other with respect to the line L while being balanced with each other. The fold rollers 3a and 3b are therefore capable of conveying the sheet S or the sheet stack S without shifting the center of the sheet S or the sheet stack S without regard to the number of sheets constituting the sheet stack S. This allow the stapled position of the sheet stack S stapled by the center stapler 5a to accurately coincide with the folded position of the same.

The fold rollers 3a and 3b withstand even heavy loads because gears or similar connecting means are not used. The sheet S or the sheet stack S can therefore be stably, accurately positioned only by the accuracy of the springs 4a and 4b, so that the configuration is simple, low cost and stable. Further, the fold rollers 3a and 3b can fold the sheet S or the sheet stack S under adequate conditions without having their pressing forces limited by short mechanical strength.

The bearings 4d1 and 4d2, respectively supporting the fold rollers 3a and 3b and movable along the guide holes 4c1 and 4c2, maybe replaced with movable arms, if desired. The springs, constituting the pressing means 4a and 4b, may, of course, be implemented by tension springs in place of compression springs shown and described.

A path 8 is positioned downstream of the fold roller pair 6 and also aligned with the line L including the locus of movement of the fold plate 2. Another pair of fold rollers or reinforce rollers 6a and 6b, collectively 6, are positioned on the path 8 downstream of the fold rollers 3a and 3b in the direction of sheet conveyance. When the leading edge or fold of the sheet S or the sheet stack S, coming out of the nip N between the fold rollers 3a and 3b, enters a N′ between the fold rollers (reinforce rollers hereinafter) 6a and 6b, the reinforce rollers 6a and 6b are caused to stop rotating. Subsequently, on the elapse of a preselected period of time, the reinforce rollers 6a and 6b are caused to rotate in the forward and reverse directions within a range that prevents the sheet or the sheet stack from slipping out of the nip N′, thereby reinforcing the fold of the sheet or the sheet stack.

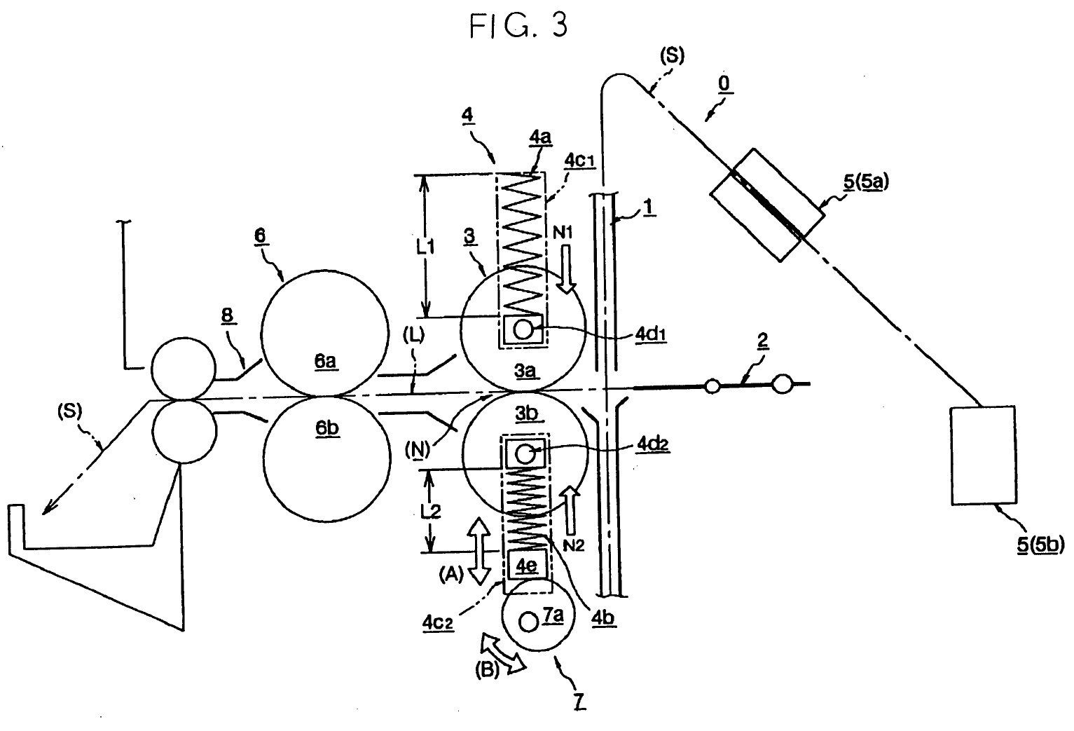

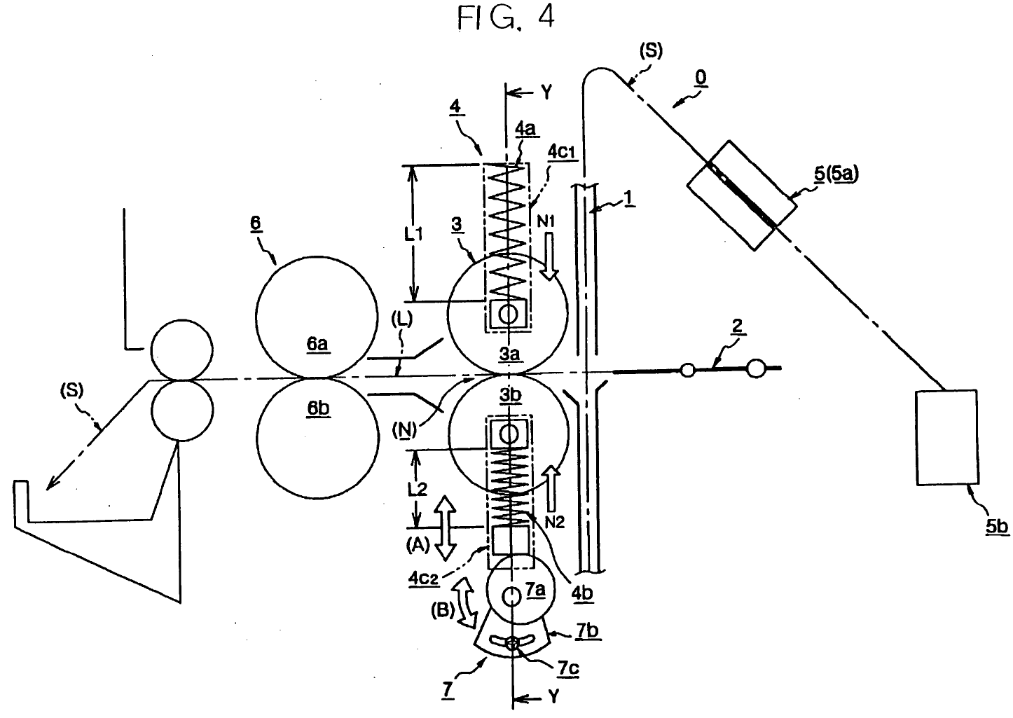

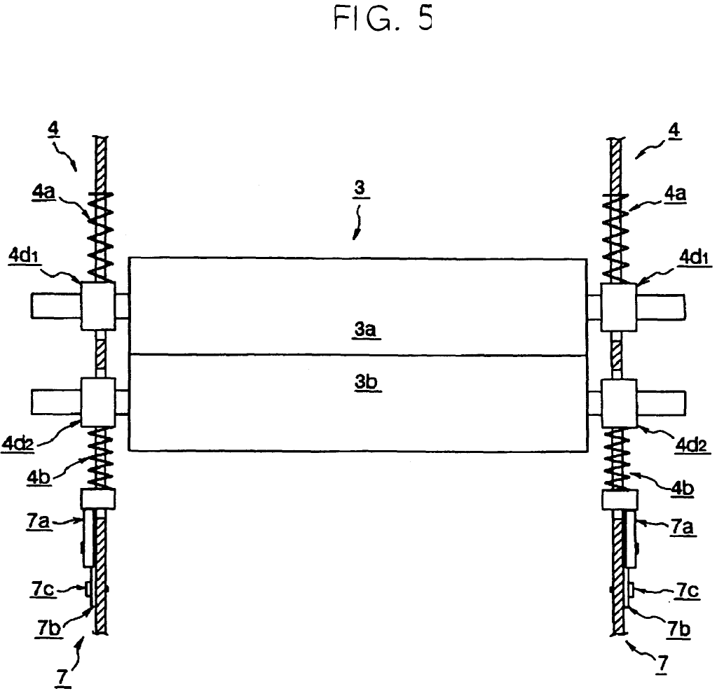

Reference will be made to FIGS. 3 through 5 for describing a modification of the illustrative embodiment. As shown in FIG. 3, the spring or lower pressing means 4b is anchored at one end to the lower bearing 4d2 and at the other end to a spring support member 4e, which is guided by the lower guide hole 4c2 in such a manner as to be movable in a direction indicated by an arrow A. The spring support member 4e is supported by an eccentric cam 7a included in pressure adjusting means 7. The eccentric cam 7a is rotatable in a direction indicated by an arrow B in FIG. 3 to thereby adjust the loaded length L2 of the spring 4b. The modification can therefore easily adjust the loaded length L2 with a simple configuration. As shown in FIGS. 4 and 5, after the adjustment of the loaded length L2, the eccentric cam 7a is locked at the adjusted position with a lock handle 7b being fastened by a screw 7c.

Therefore, even if the nip N between the fold rollers 3a and 3b is shifted from the line L after the assembly of the folding device 0, the nip N can be immediately adjusted. It follows that the nip N can be accurately positioned at all times and allows the stapled position implemented by, e.g., the center stapler 5a to accurately coincide with the folding position. This allows the sheet folding device 0 to provide the sheet or the sheet stack with a sharp fold for thereby allowing a plurality of stacks to be safely stacked without collapsing.

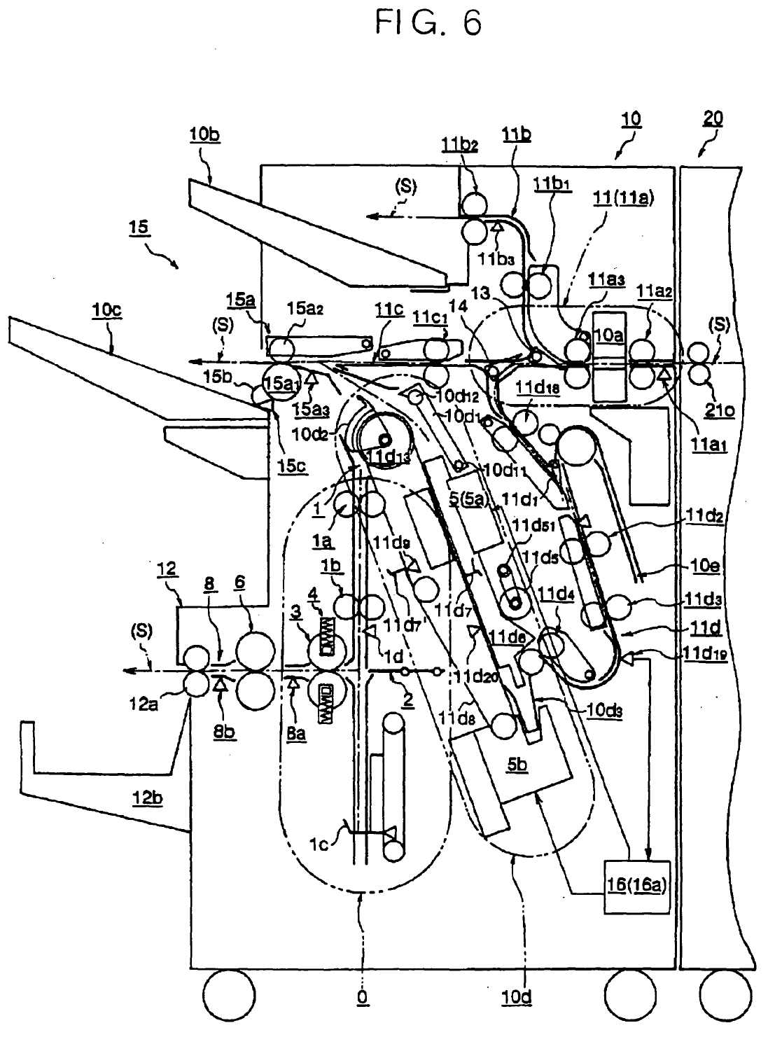

Referring to FIG. 6, a sheet finisher for finishing sheets will be described hereinafter. As shown, the finisher, generally 10, is operatively connected to an image forming apparatus 20. A sheet or recording medium S, carrying an image thereon and driven out of the image forming apparatus 20 via an outlet roller pair 210, is introduced into the sheet finisher 10 via an inlet. In the sheet finisher 10, a path 11a extends from the inlet and includes finishing means for finishing a single sheet. In the illustrative embodiment, this finishing means is implemented as a punch unit 10a. Path selectors 13 and 14 steer the sheet S coming in through the path 11a to any one of a path 11b terminating at an upper tray 10b, a path 11c terminating at a shift tray 10c, and a processing tray 10d. The processing tray 10d is used to position, staple or otherwise process a sheet or sheets and, in this sense, will be referred to as a staple tray hereinafter.

Sheets sequentially brought to the staple tray 10d via the paths 11a and 11d are positioned one by one, stapled or otherwise processed, and then steered by a guide plate 10d1 and a movable guide 10d2 to either one of the path 11c and folding device 0. The sheets folded by the folding device 0 are guided to a lower tray 12b via a path 8. The path lid includes a path selector 11d1 constantly biased to a position shown in FIG. 6 by a light-load spring not shown. An arrangement is made such that after the trailing edge of a sheet has moved away from the path selector 11d1, among a prestack roller, rollers 11d2 and 11d3 and a staple outlet roller 11d4, at least the prestack roller and roller 11d2 are rotated in the reverse direction to convey the trailing edge of the sheet to a prestacking portion 10e and cause the sheet to stay there. In this case, the sheet can be conveyed together with the next sheet superposed thereon. Such an operation may be repeated to convey two or more sheets together.

On the path 11a, merging into the paths 11b, 11c and 11d, there are sequentially arranged an inlet sensor 11a1 responsive to a sheet introduced into the finisher 20, an inlet roller pair 11a2, the punch unit 10a, a waste hopper, roller pair 11a3, and the path selectors 13 and 14. Springs, not shown, constantly bias the path selectors 13 and 14 to the positions shown in FIG. 6. When solenoids, not shown, are energized, the path selectors 13 and 14 rotate upward and downward, respectively, to thereby steer the sheet to desired one of the paths 11b, 11c and 11d.

More specifically, to guide a sheet to the path 11b, the path selector 13 is held in the position shown in FIG. 6 while the solenoid assigned thereto is deenergized. To guide a sheet to the path 11c, the solenoids are energized to rotate the path selectors 13 and 14 upward and downward, respectively. Further, to guide a sheet to the path 11d, the path selector 14 is held in the position shown in FIG. 6 while the solenoid assigned thereto is turned off; at the same time, the solenoid assigned to the path selector 13 is turned on to rotate it upward.

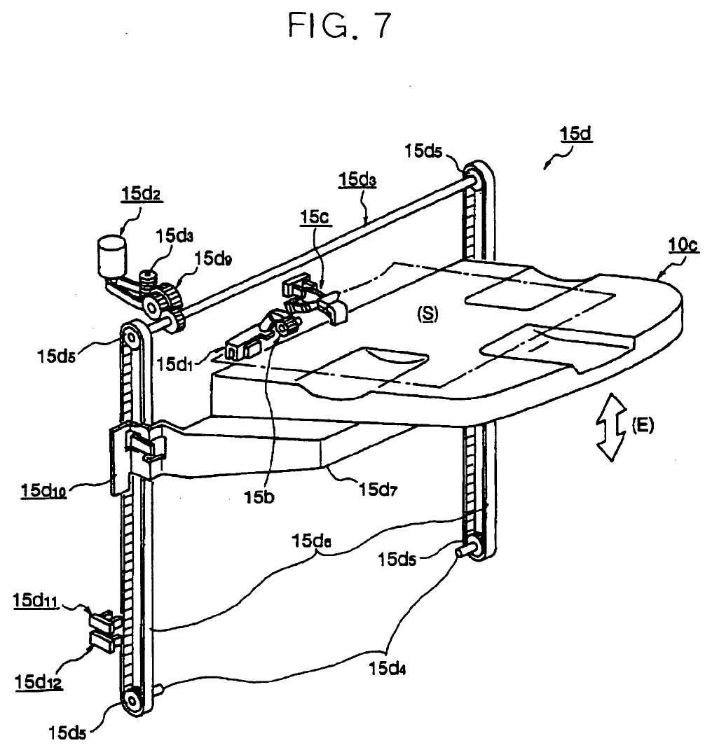

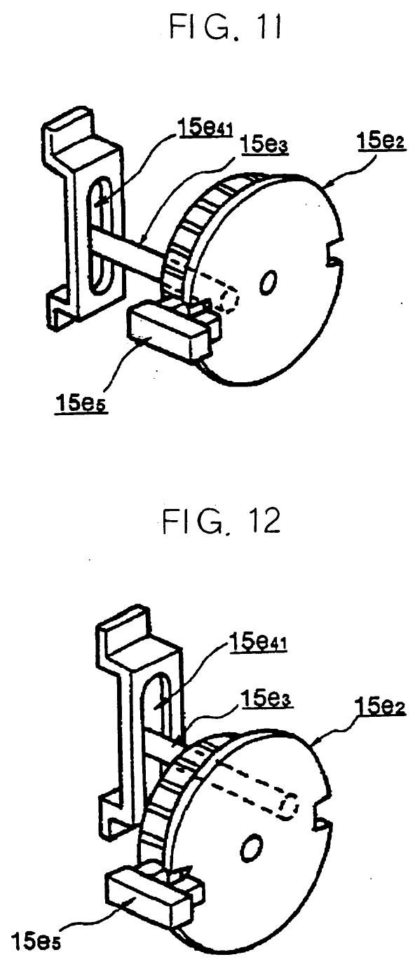

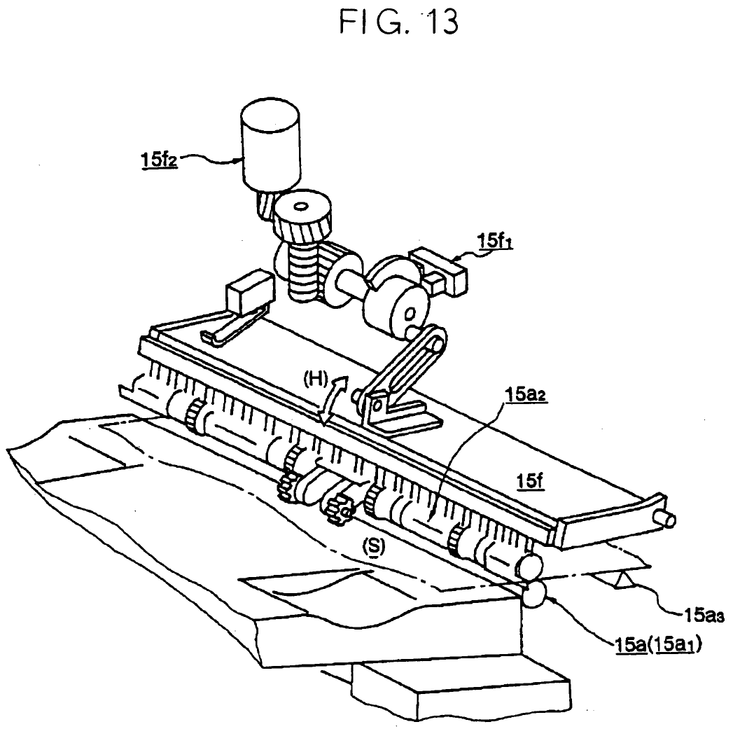

A shift tray outlet section 15, is located at the most downstream position of the sheet finisher 10 and includes a pair of shift outlet rollers 15a1 and 15a2, collectively 15, a return roller 15b, a sheet surface sensor 15c, and the shift tray 10c. The shift tray outlet section 15 additionally includes a shifting mechanism 15e, see FIGS. 10 through 12, and a shift tray elevating mechanism 15d, see FIGS. 7 through 9.

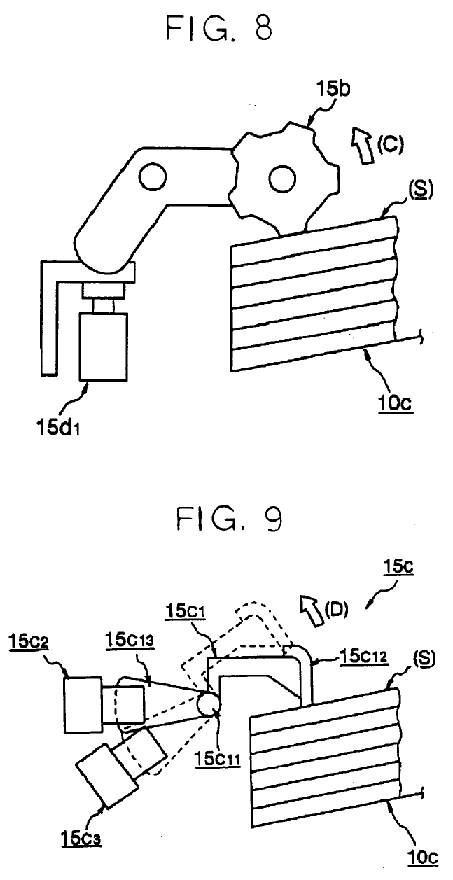

As shown in FIGS. 7 and 8, the return roller 15b contacts a sheet driven out by the shift outlet roller pair 15a and causes the trailing edge of the sheet to abut against an end fence, not shown, for thereby positioning it. The return roller 15b is formed of sponge and caused to rotate by the shift outlet roller pair 15a. A limit switch 15d1 is positioned in the vicinity of the return roller 15b such that when the shift tray 10c is lifted and raises the return roller 15b, the limit switch 15d1 turns on, causing a tray elevation motor 15d2 to stop rotating. This prevents the shift tray 10c from overrunning. As shown in FIG. 6, the sheet surface sensor 15c senses the surface of a sheet or that of a sheet stack driven out to the shift tray 10c.

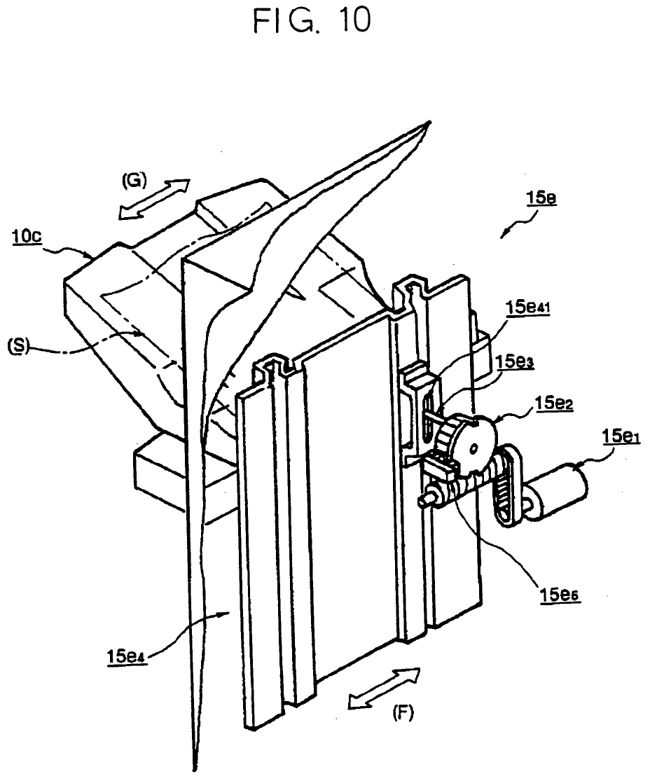

As shown in FIG. 9 specifically, the sheet surface sensor 15c is made up of a lever 15c1, a sensor 15c2 relating to stapling, and a sensor 15c3 relating to non-stapling. The lever 15c1 is angularly movable about its shaft portion and made up of a contact end 15c12 contacting the top of the trailing edge of a sheet on the shift tray 10c and a sectorial interrupter 15c13. The upper sensor 15c2 and lower sensor 15c3 are mainly used for staple discharge control and shift discharge control, respectively.

More specifically, in the illustrative embodiment, the sensors 15c2 and 15c3 each turn on when interrupted by the interrupter 15c13 of the lever 15c1. Therefore, when the shift tray 19c is lifted with the contact end 15c12 of the lever 15c1 moving upward, the sensor 15c2 turns off. As the shift tray 10c is further lifted, the sensor 15c3 turns off. When the outputs of the sensors 15c2 and 15c3 indicate that sheets are stacked on the shift tray 10c to a preselected height, the tray elevation motor 15d2 is driven to lower the shift tray 10c by a preselected amount. The top of the sheet stack on the shift tray 10c is therefore maintained at a substantially constant height.

The shift tray elevating mechanism 15d will be described in detail with reference to FIG. 7. As shown, the mechanism 15d includes a drive unit for moving the shift tray 10c upward or downward via a drive shaft 15d3. Timing belts 15d6 are passed over the drive shaft 15d3 and a driven shaft 15d4 under tension via timing pulleys 15d5. A side plate 15d7 supports the shift tray 10c and is affixed to the timing belts 15d6. In this configuration, the entire unit including the shift tray 10c is supported by the timing belts 15d6 in such a manner as to be movable up and down.

The drive unit includes a worm gear 15d8 in addition to the tray elevation motor 15d2, which is a reversible drive source. Torque output from the tray elevation motor 15d2 is transmitted to the last gear of a gear train mounted on the drive shaft 15d3 to thereby move the shift tray 10c upward or downward. The worm gear 15d8 included in the driveline allows the shift tray 10c to be held at a preselected position and therefore prevents it from dropping by accident.

An interrupter 15d10 is formed integrally with the side plate 15d7 of the shift tray 10c. A full sensor 15d11 responsive to the full condition of the shift tray 10c and a lower limit sensor 15d12 responsive to the lower limit position of the shift tray 10c are positioned below the interrupter 15d10. The full sensor 15d11 and lower limit sensor 15d12, which are implemented by photosensors, each turn off when interrupted by the interrupter 15d10. In FIG. 7, the drive roller 15a1 and 15a2, constituting the shift outlet roller pair 15, are not shown.

FIGS. 10 through 12 show the shifting mechanism 15a. As shown in FIG. 10, the shifting mechanism 15a includes a shift motor 15e1 and a cam 15e2. When the shift motor or drive source 15e1 causes the cam 15e2 to rotate, the cam 15e2 causes the shift tray 10c to move back and forth in a direction perpendicular to a direction of sheet discharge. A pin 15e3 is studded on the shift cam 15e2 at a position spaced from the axis of the shift cam 15e2 by a preselected distance. The tip of the pin 15e3 is movably received in an elongate slot 15e41 formed in an end fence 15e4, which guides the rear edge of the sheets S stacked on the shift tray 10c. The end fence 15e4 moves back and forth in a direction perpendicular to the direction of sheet discharge in accordance with the angular position of the pin 15e3, entraining the shift tray 10c in the same direction. The shift tray 10c stops at a front position and a rear position in the direction perpendicular to the sheet surface of FIG. 6. A shift sensor 15e5 is responsive to a notch formed in the shift cam 15e2. To stop the shift tray at the above two positions, the shift motor 15e1 is selectively energized or deenergized on the basis of the output of the shift sensor 336.

FIG. 13 shows a specific configuration of the arrangement for discharging a sheet to the shift tray 10c. The shift roller pair 15a has a drive roller 15a1 and a driven roller 15a2. A guide plate 15f is supported at its upstream side in the direction of sheet discharge and angularly movable in the up-and-down direction. The driven roller 15a2 is supported by the guide plate 15f and contacts the drive roller 15a1 due to its own weight or by being biased, nipping a sheet between it and the drive roller 15a1. When a stapled sheet stack is to be driven out to the shift tray 10c, the guide plate 15f is lifted and then lowered at a preselected timing, which is determined on the basis of the output of a guide plate sensor 15f1. A guide plate motor 15f2 drives the guide plate 15f.

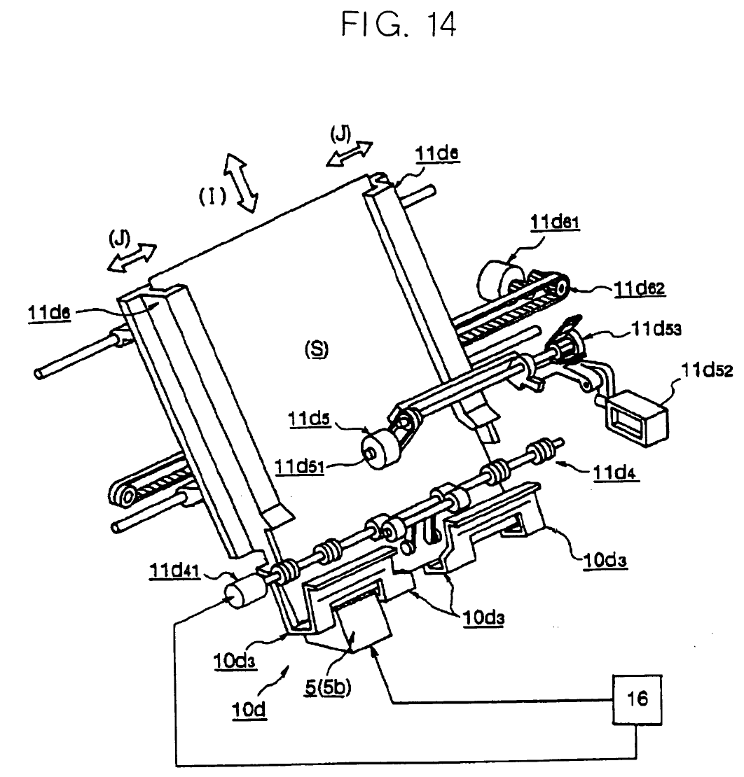

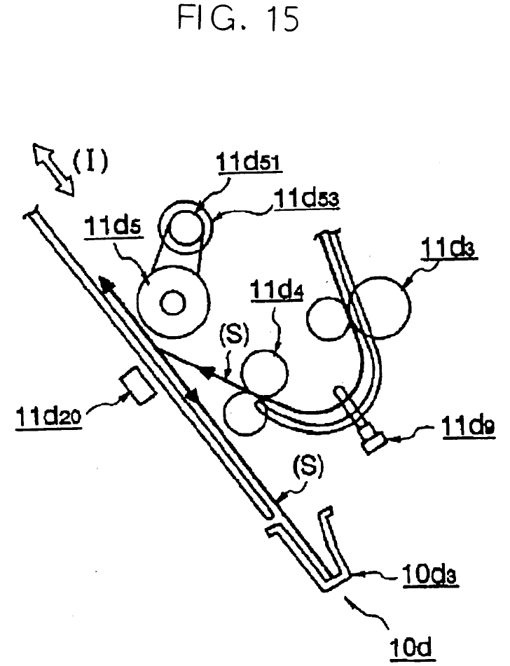

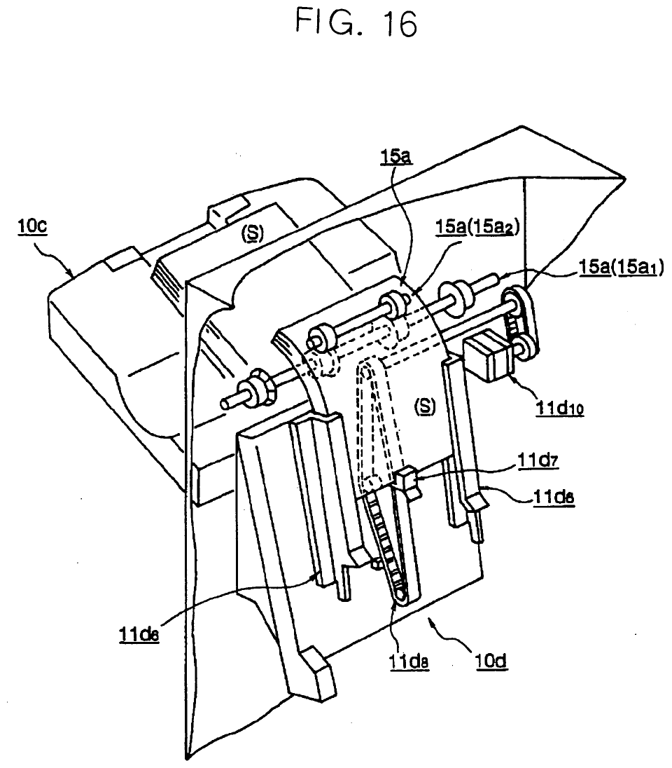

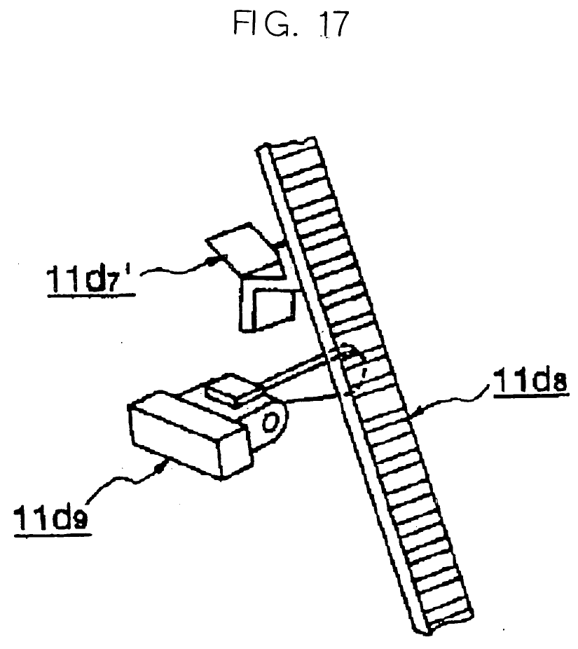

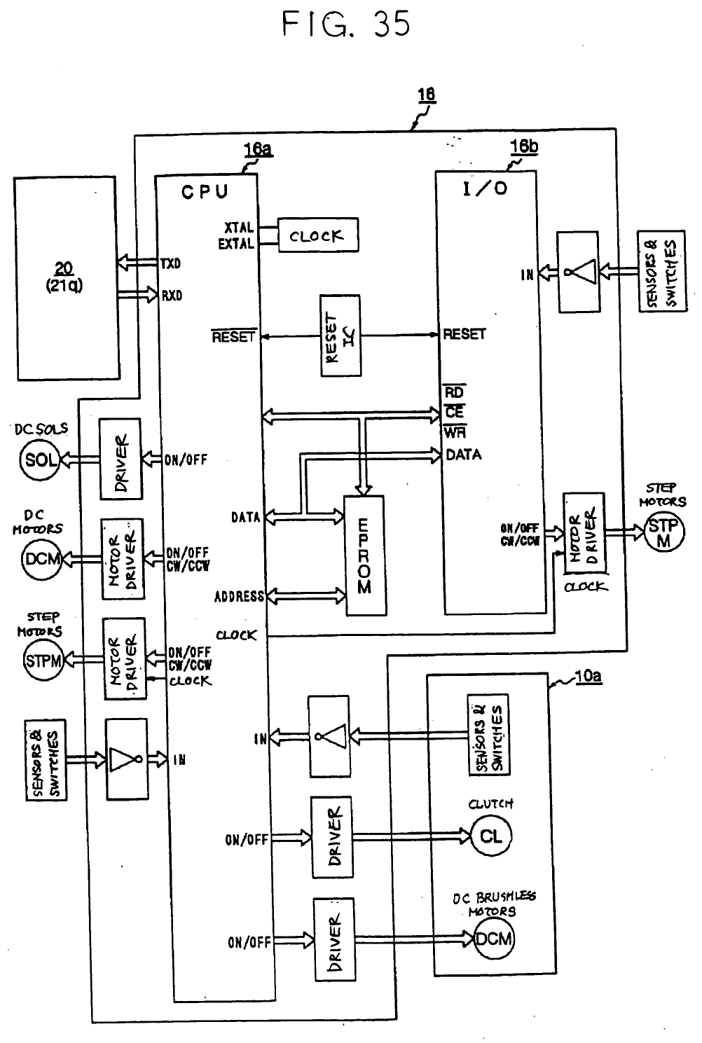

FIGS. 14 through 20 show the staple tray 10d for allowing the center stapler 5a and edge stapler 5b to staple a sheet stack at the center and the edge, respectively. As shown in FIGS. 14 and 15, sheets sequentially conveyed by the staple outlet roller pair 11d4 to the staple tray 10d are sequentially stacked on the staple tray 10d. At this instant, a knock roller 11d5 knocks every sheet for positioning it in the vertical direction (direction of sheet conveyance) while jogger fences 11d6 position the sheet in the horizontal direction perpendicular to the sheet conveyance (sometimes referred to as a direction of sheet width). Between consecutive jobs, i.e., during an interval between the last sheet of a sheet stack and the first sheet of the next sheet stack, a controller 16, see FIG. 35, outputs a staple signal for causing an edge stapler 5b to perform a stapling operation. A discharge belt 11d8 with a hook 11d7 immediately conveys the stapled sheet stack to the shift outlet roller pair 15a, so that the shift outlet roller pair 15a conveys the sheet stack to the shift tray 10c held at a receiving position, as shown in FIGS. 16 and 17.

As shown in FIG. 17, a belt HP (Home Position) sensor 11d9 senses the hook 11d7 of the discharge belt 11d8 brought to its home position. More specifically, two hooks 11d7 are positioned on the discharge belt 11d8 face-to-face at spaced locations in the circumferential direction and alternately convey sheet stacks stapled on the staple tray 10d one after another. The discharge belt 11d8 may be moved in the reverse direction such that one hook 11d7 held in a stand-by position and the back of the other hook 11d7′ position the leading edge of the sheet stack stored in the staple tray 10d in the direction of sheet conveyance, as needed. The hook 11d7 therefore plays the role of positioning means at the same time.

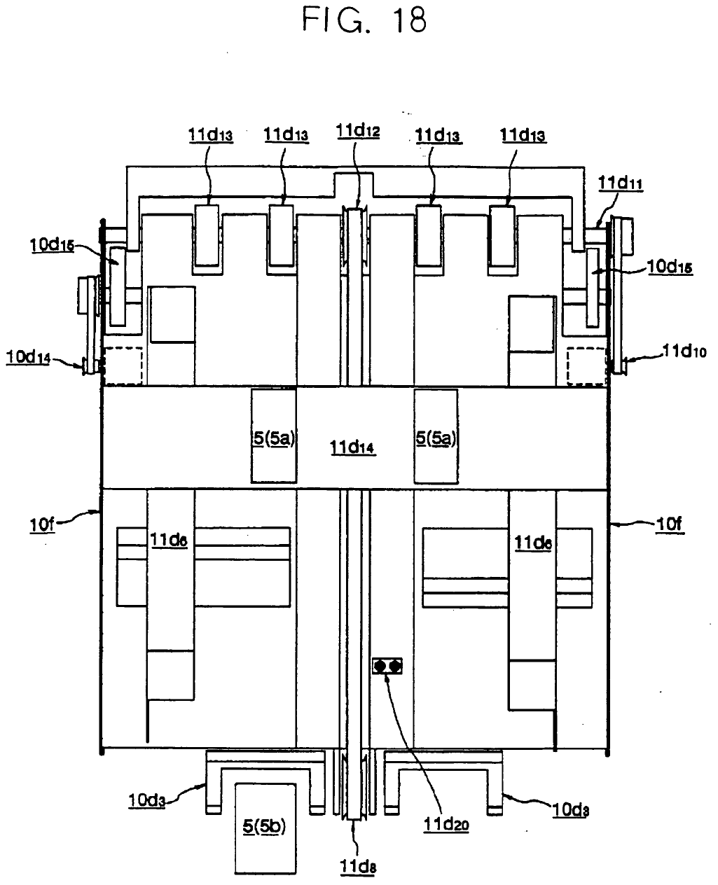

As shown in FIG. 18, a discharge motor 11d10 causes the discharge belt 11d8 to move via a discharge shaft 11d11. The discharge belt 11d8 and a drive pulley 11d12 therefor are positioned at the center of the discharge shaft 11d11 in the direction of sheet width. Discharge rollers 11d13 are mounted on the discharge shaft 11d11 in a symmetrical arrangement. The discharge rollers 11d13 rotate at a higher peripheral speed than the discharge belt 11d8.

A processing mechanism will be described hereinafter. As shown in FIGS. 14 and 15, a solenoid (SOL) 11d52 causes the knock roller 11d5 to move about a fulcrum 11d51 in a pendulum fashion, so that the knock roller 11d5 intermittently acts on sheets sequentially driven to the staple tray 10d and causes their trailing edges to abut against rear fences 10d3. The knock roller 11d5 rotates counterclockwise about its axis. A jogger motor 11d61 drives the jogger fences 10d3 via a timing belt and causes them to move back and forth in the direction of sheet width.

As shown in FIGS. 6 and 18, a pair of center staplers 5a are affixed to a stay 11d4 and are located at a position where the distance between the rear fences 10d3 and their stapling positions is equal to or greater than one-half of the length of the maximum sheet size, as measured in the direction of conveyance, that can be stapled. The center staplers S2 are symmetrical to each other with respect to the center in the direction of sheet width. The center staplers S2 themselves are conventional and will not be described specifically.

As shown in FIG. 19, a mechanism for moving the edge stapler 5b includes a reversible, stapler motor 11d15 for driving the edge stapler 5b via a timing belt. The edge stapler 5b is movable in the direction of sheet width in order to staple a sheet stack at a desired edge position. A stapler HP sensor 11d17 is positioned at one end of the movable range of the edge stapler 5b in order to sense the stapler 5b brought to its home position. The stapling position in the direction of sheet width is controlled in terms of the displacement of the edge stapler 5b from the home position.

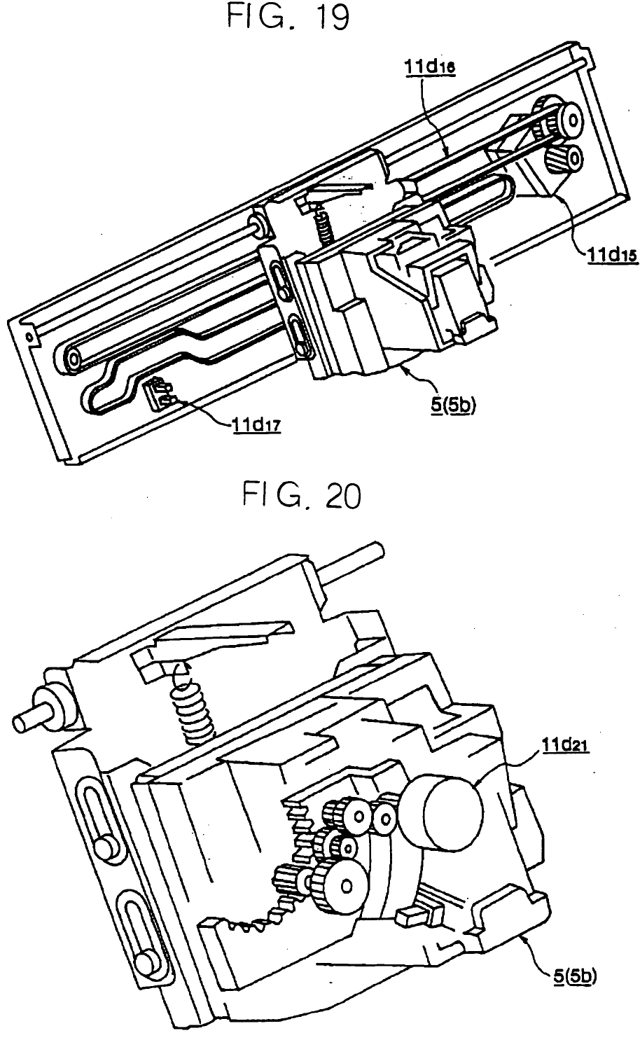

As shown in FIG. 20, the edge stapler 5b is capable of selectively driving a staple into a sheet stack in parallel to or obliquely relative to the edge of the sheet stack. Further, at the home position, only the stapling mechanism portion of the edge stapler 5b is rotatable by a preselected angle for the replacement of staples. For this purpose, an oblique motor 11d21 causes the above mechanism of the edge stapler 5b to rotate

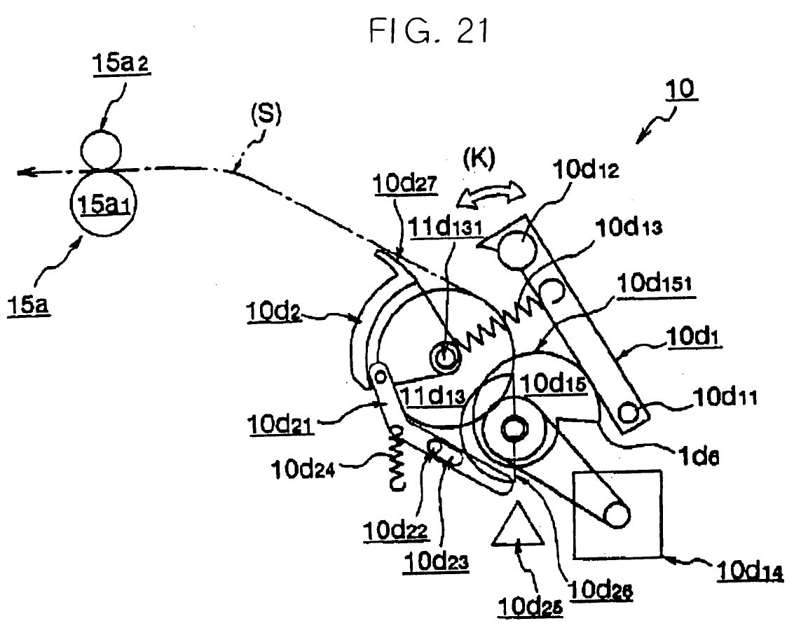

Reference will be made to FIGS. 21 through 23 for describing a specific mechanism for driving the guide plate 10d1. As shown, the mechanism includes the guide plate or steering means 54 and movable guide 55 mentioned earlier. The guide plate 10d1 is angularly movable about a fulcrum 10d11 in the up-and-down direction and supports a press roller 10d12, which is freely rotatable, on its downstream end. A spring 10d13 constantly biases the guide plate 10d1 toward the discharge roller 11d13. The guide plate 11d1 is held in contact with the cam surface 10151 of a cam 10d15, which is driven by a steer motor 10d14.

The movable guide 10d2 is angularly movably mounted on the shaft 11d131 of the discharge roller 11d13. A link arm 10d21 is connected to one end of the movable guide 10d2 remote from the guide plate 10d1 at a joint. A pin 10d22, studded on a front sidewall 10f shown in FIG. 18, is movably received in an elongate slot 10d23 formed in the link arm 10d21, limiting the movable range of the movable guide 10d2. A spring 10d13 holds the link arm 10d21 in the position shown in FIG. 21.

When the steer motor 19d1 causes the cam 10d15 to rotate to a position where its cam surface 10d151 presses the link arm 10d21, the movable guide 10d2 connected to the link arm 10d21 angularly moves upward. A guide HP sensor 10d25 senses the home position of the cam 10d15 on sensing the interrupter portion 10d26 of the cam 10d15. Therefore, the stop position of the cam 10d15 is controlled on the basis of the number of drive pulses input to the steer motor 10d14 counted from the home position of the cam 10d15, as will be described later in detail.

FIG. 21 shows a positional relation to hold between the guide plate 10d1 and the movable guide 10d2 when the cam 10d15 is held at its home position. As shown, the guide surface 10d27 of the movable guide 10d2 guides a sheet stack S on the path extending between the shift outlet roller 15a and the drive roller 15a1 and driven roller 15a2.

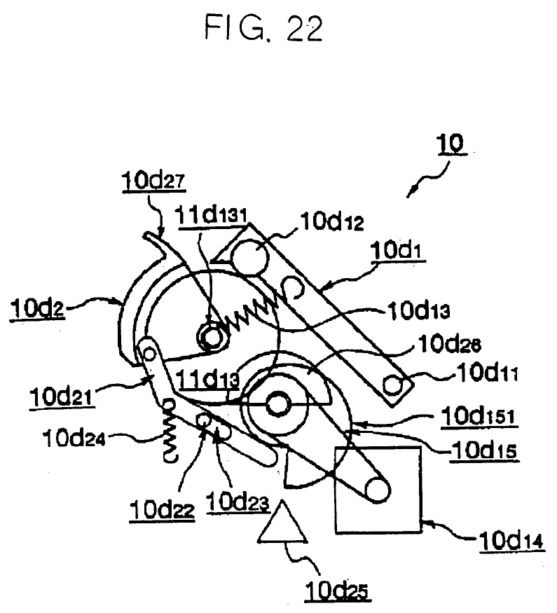

FIG. 22 shows a condition wherein the guide plate 10d1 is caused to move downward by the cam 1-d15 with the press roller 10d12 pressing the discharge roller 11d13.

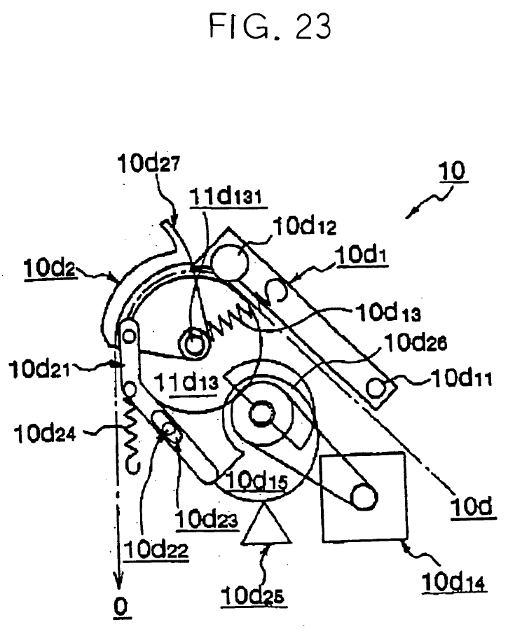

FIG. 23 shows a condition wherein the cam 10d15 has further rotated from the above position to move the movable guide 10d2 upward. In this condition, the guide plate 10d1 and movable guide 10d2 form the route extending from the staple tray 10d toward the folding device 0. FIG. 18 shows the same relation as seen in the direction of depth.

While in the illustrative embodiment the guide plate 10d1 and movable guide 10d2 share a single drive motor, each of them may be driven by a respective drive motor, so that the timing of movement and stop position can be controlled in accordance with the sheet size and the number of sheets stapled together.

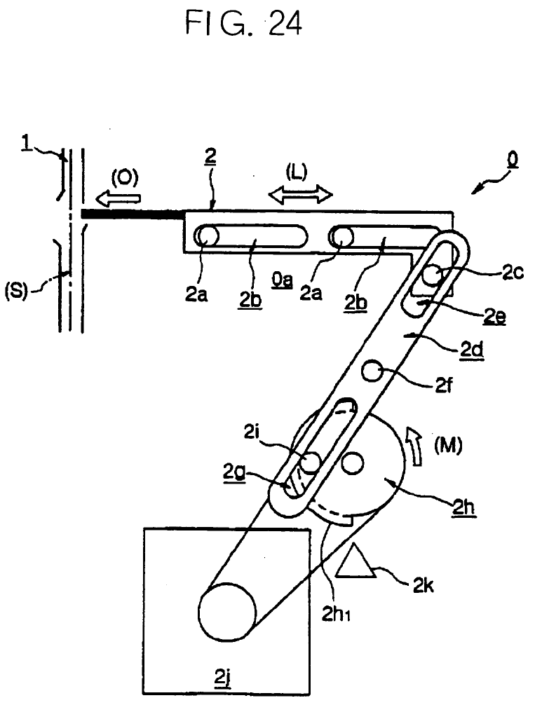

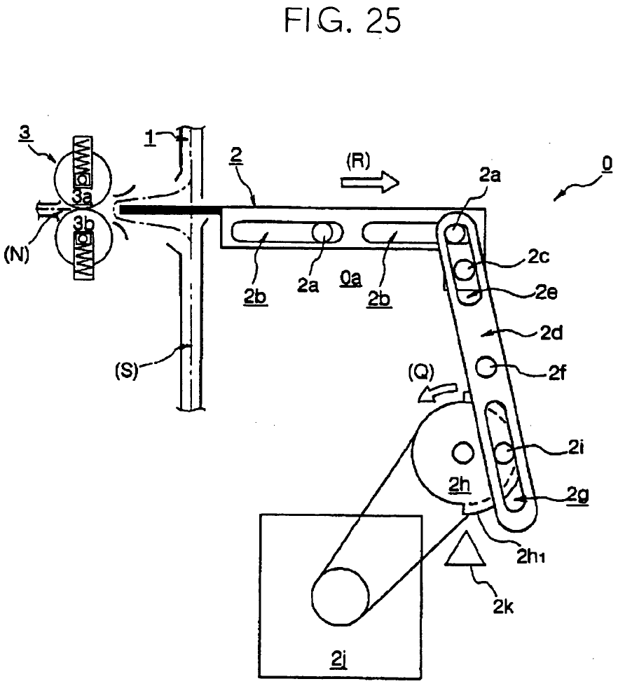

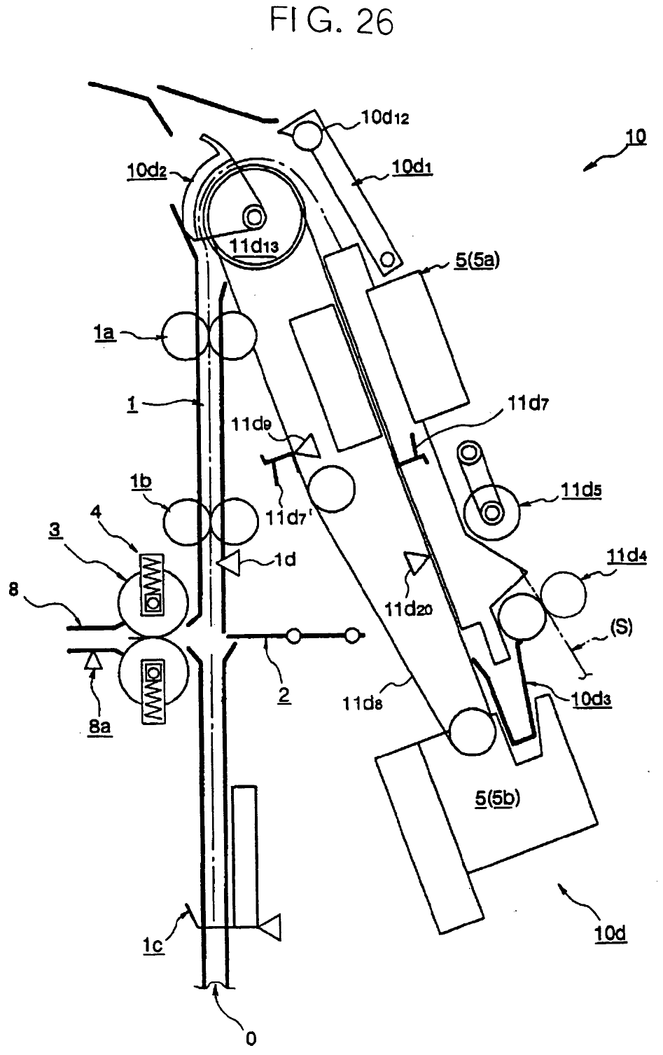

As shown in FIGS. 24 and 25, the fold plate 2 included in the folding device 0 is formed with elongate slots 2b each being movably received in one of pins 2a studded on each of the front and rear side walls of the device body 0a. A pin 2c studded on the fold plate 2 is movably received in an elongate slot 2e formed in a link arm 2d. The link arm 2d is angularly movable about a fulcrum 2f, causing the fold plate 2 to move in the right-and-left direction indicated by an arrow L. More specifically, a pin 2i studded on a fold plate cam 2h is movably received in an elongate slot 2g formed in the link arm 2d. In this condition, the link arm 2d angularly moves in accordance with the rotation of the fold plate cam 2h.

A fold plate motor 2j causes the fold plate cam 2h to rotate in a direction indicated by an arrow M. The stop position of the fold plate cam 2h is determined on the basis of the output of a fold plate HP sensor 2k responsive to the opposite ends of a semicircular interrupter portion 2h1 included in the cam 2h.

FIG. 24 shows the fold plate 2 in the home position where the fold plate 2 is fully retracted from the sheet stack storing range of the fold tray. When the fold plate cam 2h is rotated in the direction indicated by the arrow M, the fold plate 2 is moved in the direction indicated by an arrow O and enters the sheet stack storing range of the path 1. FIG. 25 shows a position where the fold plate 2 pushes the center of a sheet stack on the fold tray into the nip N between the fold rollers 3a and 3b. When the fold plate cam 2h is rotated in a direction indicated by an arrow Q, the fold plate 2 moves in a direction indicated by an arrow R out of the sheet stack storing range of the path 1.

Referring again to FIG. 6, the sheet finisher 10 is selectively operable in any one of a non-staple mode (a), a non-staple mode (b), a sort/stack mode, a staple mode, and a center staple and bind mode. In the non-staple mode (a), sheets S are routed from the path 11a to the upper tray 10a via the path 11b while, in the non-staple mode (b), sheets S are routed from the path 11a to the shift tray 10c via the path 11c. The sort/stack mode is similar to the non-staple mode (b) except that the shift tray 10c is repeatedly shifted in the direction perpendicular to the direction of sheet conveyance copy by copy. In the staple mode, sheets S are delivered from the path 11a to the staple tray 10d via the path 11d, stapled on the staple tray 10d, and then delivered to the shift tray 10c via the path 11c. Further, in the center staple and bind mode, sheets S stapled at the center on the staple tray 10d, is folded on the path and then driven out to the lower tray 12b via the outlet roller pair 12a.

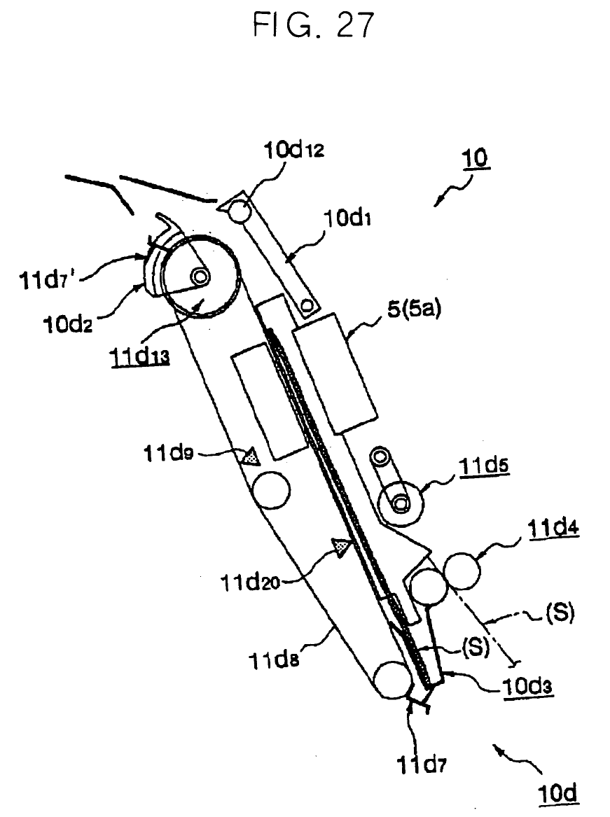

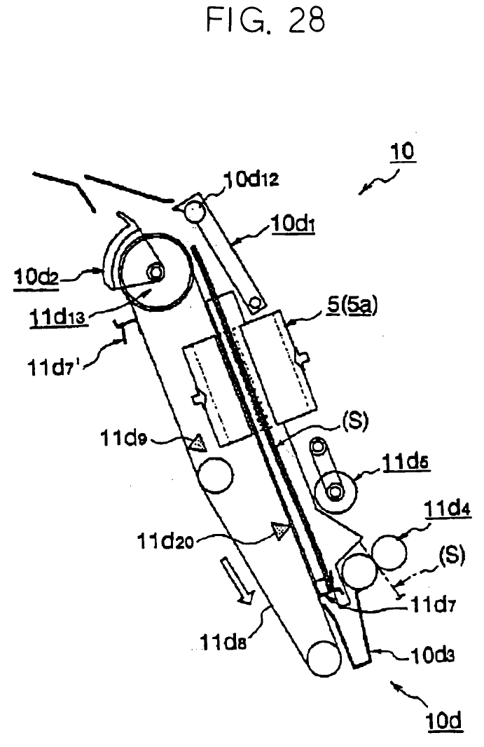

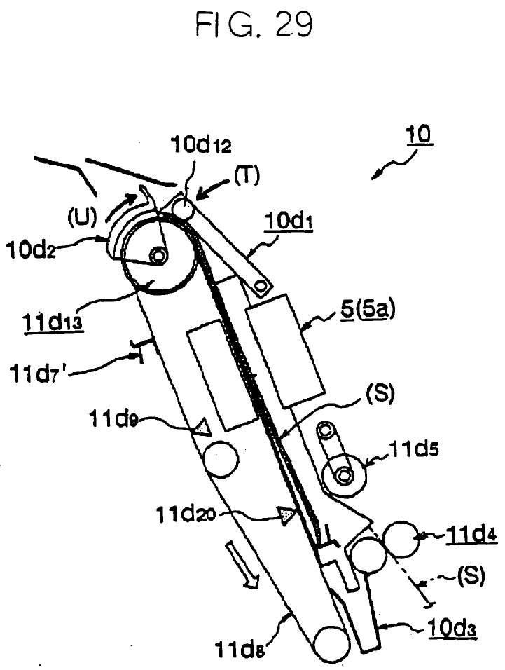

The center staple and bind mode will be described in more detail with reference to FIGS. 26 through 34 hereinafter. As shown, a sheet S is steered by the path selectors 13 and 14 to the path lid and then conveyed by the roller pairs 11d18, 11d2, 11d3 and 11d4 to the staple tray 10d. The staple tray 10d operates in exactly the same manner as in the staple mode stated earlier before positioning and stapling, see FIGS. 26 and 27. Subsequently, as shown in FIG. 28, the hook 11d7 conveys the sheet stack to the downstream side in the direction of conveyance by a distance matching with the sheet size.

After the center staplers 5a have stapled the center of the sheet stack, the sheet stack is conveyed by the hook 62a to the downstream side by a preselected distance matching with the sheet size and then brought to a stop. The distance of movement of the sheet stack is controlled on the basis of the drive pulses input to the discharge motor 11d10, see FIGS. 16 and 18.

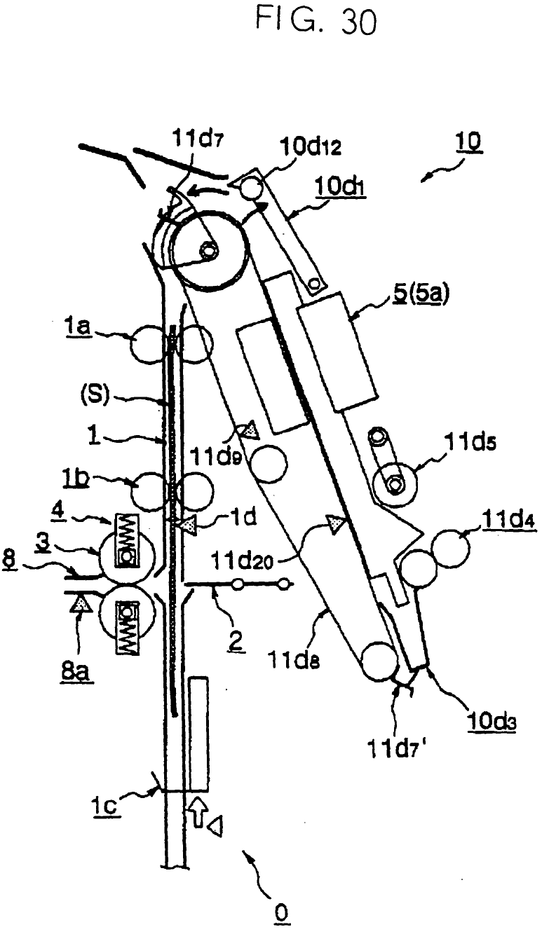

Subsequently, the sheet stack is nipped by the discharge roller 11d13 and press roller 10d12 and then conveyed by the hook 11d7 and discharge roller 11d13 to the downstream side such that it passes through the path formed between the guides 10d1 and 10d2, which are respectively moved in directions T and U, and extending to the path 1. The discharge roller 11d13 is mounted on the drive shaft 11d11 associated with the belt 11d8 and therefore driven in synchronism with the belt 11d8, as stated earlier. Subsequently, the sheet stack is conveyed by the upper and lower roller pairs 1a and 1b of the folding device 0 to the movable rear fence 1c, which is moved from its home position to a position matching with the sheet size beforehand and held in a stop for guiding the lower edge of the sheet stack S. At this instant, as soon as the other hook 11d7′ on the belt 11d8 arrives at a position close to the rear fence 10d3, the hook 11d7 is brought to a stop while the guides 10d1 and 10d2 are returned to the home positions to wait for the next sheet stack, as shown in FIG. 30.

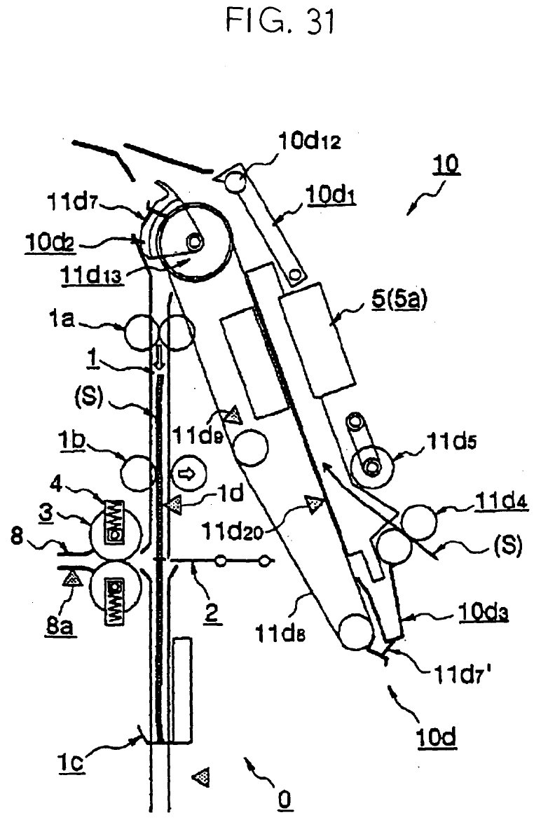

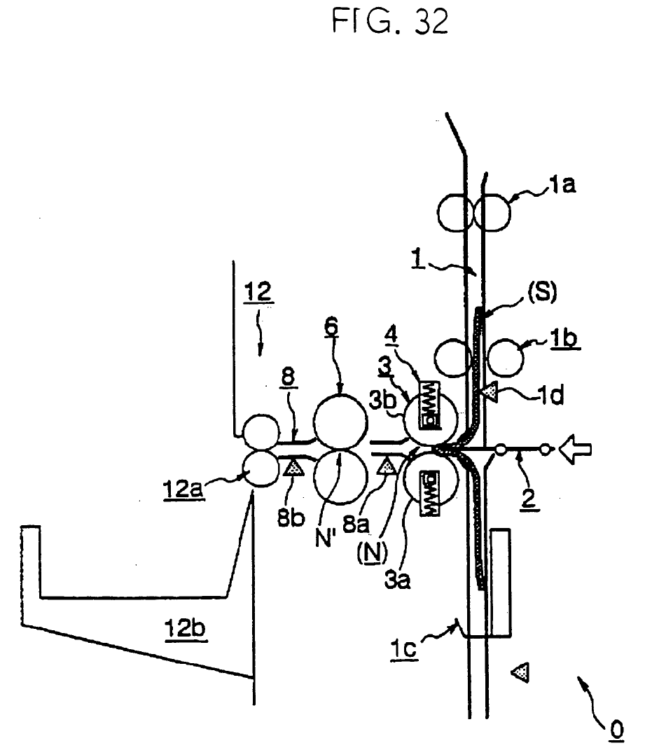

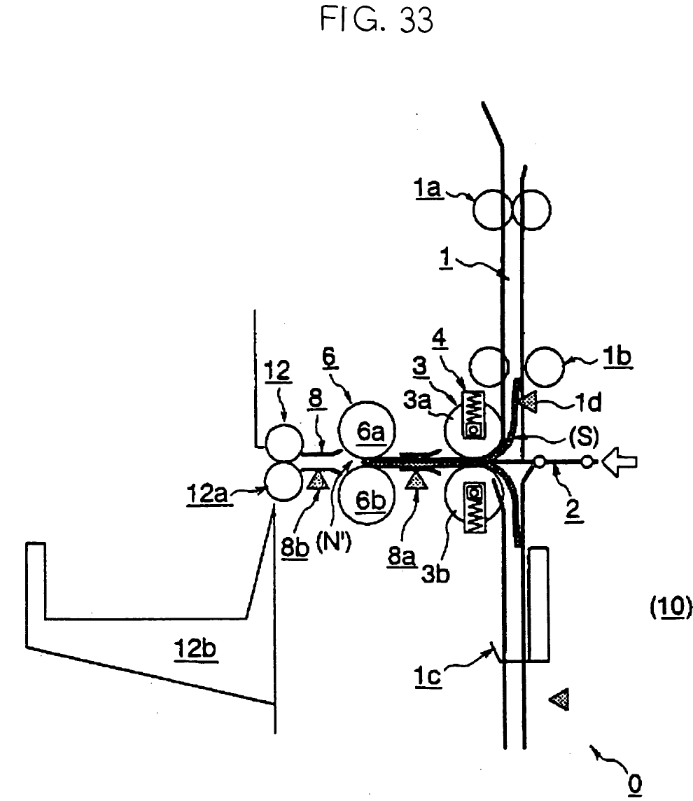

As shown in FIG. 31, the sheet stack S abutted against the movable rear fence 1c is freed from the pressure of the lower roller pair 1b. Subsequently, the fold plate 2 pushes part of the sheet stack close to a staple toward the nip of the fold roller pair 3 substantially perpendicularly to the sheet stack. The fold roller pair 3, which is caused to rotate beforehand, conveys the sheet stack reached its nip while pressing it. As a result, the sheet stack is folded at its center, as shown in FIG. 32.

As shown in FIG. 33, the leading edge of the center-folded sheet stack S enters the nip N′ of the reinforce roller pair 6. At this time, the fold rollers 3a and 3b are caused to stop rotating and then, on the elapse of a preselected period of time, resume the conveyance of the sheet stack. It is noteworthy that the preselected period of time mentioned above is variable in accordance with the number of sheets and sheet size. For example, when the number of sheets constituting a stack is relatively large, a substantial period of time elapses until the next sheet stack enters the folding section. In such a case, the above period of time may be added to the preselected period of time, so that the fold of the sheet stack can be made sharper or more firm without degrading the productivity of the image forming apparatus 20. Further, the reinforce rollers 6a and 6b may be repeatedly rotated in opposite directions within the preselected period of time by an amount small enough to prevent the leading edge of the sheets stack from slipping out of the nip of the fold roller pair 6, which is about several millimeters wide. This will stroke and thereby reinforce the fold of the sheet stack.

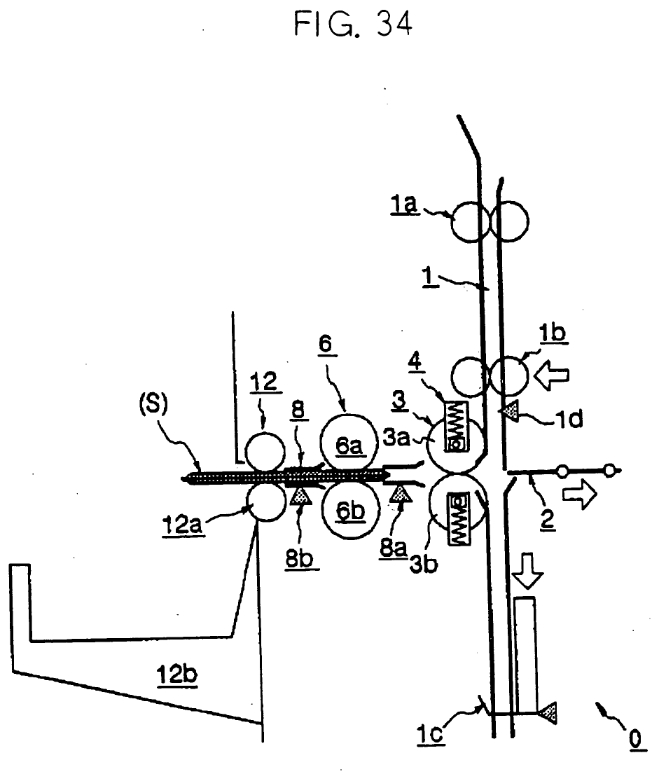

As shown in FIG. 34, the sheet stack S with the fold reinforced by the reinforce roller pair 6 is driven out to the lower tray 12b by the lower outlet roller pair 12a via the path 8. At this instant, as soon as the pass sensor 8a senses the trailing edge of the sheet stack S, the fold plate 2 and movable rear fence 1c are returned to their home positions while the lower roller pair 1b is released from each other so as to wait for the next sheet stack. Alternatively, the rear fence 1c may be held at the same position without being returned to the home position if the next job deals with the same sheet size and the same number of sheets.

Reference will be made to FIG. 35 for describing a control system included in the illustrative embodiment. As shown, the control system includes the previously mentioned control means 16 implemented as a microcomputer including a CPU (Central Processing Unit) 16a and an I/O (Input/Output) interface 16. The outputs of various switches arranged on a control panel 21q mounted on the image forming apparatus 20 and the outputs of various sensors, including the sheet sensor 15c, are input to the CPU 16a via the I/O interface 16b.

The CPU 6a controls, based on the above various inputs, the tray motor 15d2 assigned to the shift tray 10c, the guide plate motor 15f2 assigned to the guide plate 15f, the shift motor 15e1 assigned to the shift tray 10c, knock roller motor 11d53 assigned to the knock roller 11d5, various solenoids including the knock solenoid (SOL) 11d52, motors for driving the conveyor rollers, outlet motors for driving the outlet rollers, the discharge motor 11d10 assigned to the belt 11d8, the stapler motor 11d15 assigned to the edge stapler 5b, the oblique motor 11d21 for causing the edge staplers 5b to move obliquely, the jogger motor 11d61 assigned to the jogger fences 11d6, the steer motor 10d14 assigned to the guide plate 10d1 and movable guide 10d2, a rear fence motor, not shown, assigned to the movable rear fence 73, the fold plate motor 2j assigned to the fold plate 2, and a mold roller motor, not shown, assigned to the fold roller 3b of the fold roller pair 3. The pulse signals of the staple conveyance motor 11d41 assigned to the staple discharge rollers 11d4 are input to the CPU 16a and counted thereby. The CPU 16a controls the knock SOL 11d52 and jogger motor 11d61 in accordance with the number of pulse signals counted, see FIG. 14.

Specific operations to be executed by the CPU 16a in various modes available with the illustrative embodiment will be described hereinafter.

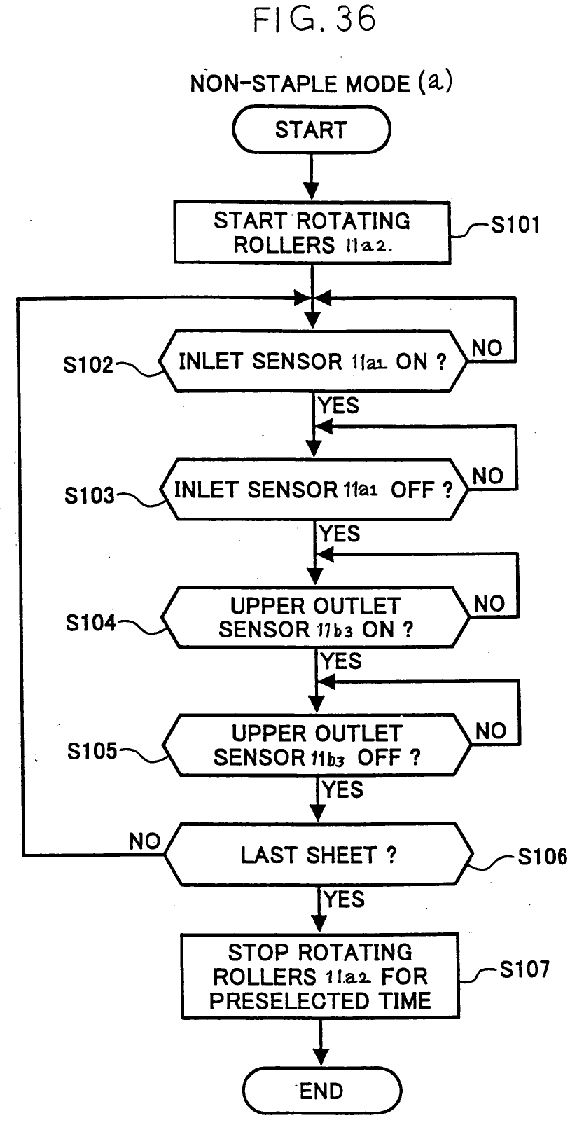

First, reference will be made to FIG. 36 for describing the non-staple mode (a) more specifically. As shown, before a sheet S driven out of the image forming apparatus 20 enters the finisher 10, the CPU 16a causes the inlet roller pair 11a2 and conveyor roller pair 11a3 on the path 11a, the roller pair 11b1 on the path 11b and outlet roller pair 11b2 to start rotating (step S101). The CPU 16a then checks the ON/OFF state of the inlet sensor 11a1 (steps S102 and S103) and the ON/OFF state of the upper outlet sensor 11b3 (steps S014 and S105) for thereby confirming the passage of sheets S. When a preselected period of time elapses since the passage of the last sheet S (YES, step S106), the CPU 16a causes the above rollers to stop rotating (step S107). In this manner, all the sheets S handed over from the image forming apparatus 20 to the finisher 10 are sequentially stacked on the upper tray 201 without being stapled. If desired, the punch unit 10a, which intervenes between the inlet roller pair 11a2 and conveyor roller pair 11a3, may punch the consecutive sheets S.

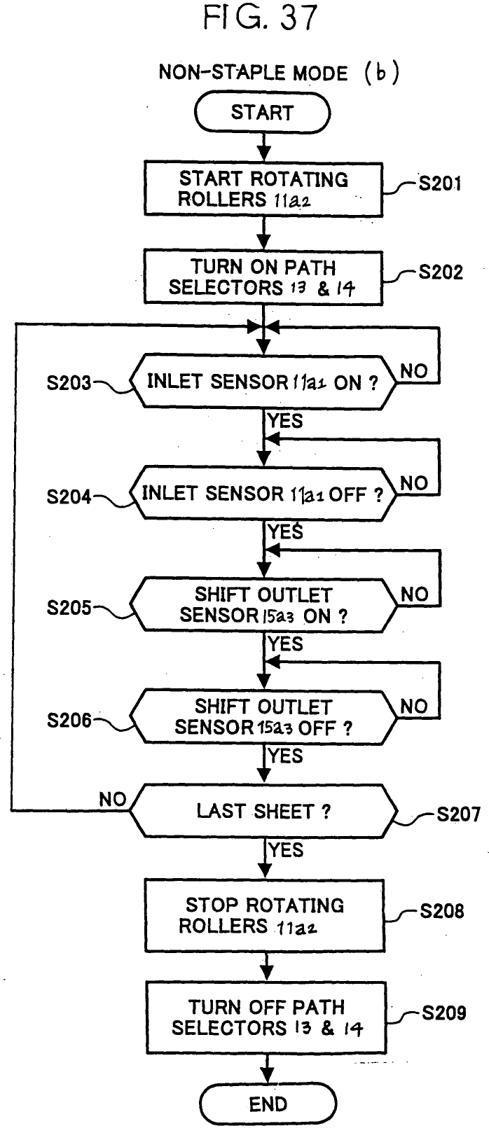

FIG. 37 demonstrates the non-staple mode (b). As shown, before a sheet S driven out of the image forming apparatus 20 enters the finisher 10, CPU 16a causes the inlet roller pair 11a and conveyor roller pair 11a on the path 11a and the roller pair 11c1 and shift outlet roller pair 15a on the path 11c start rotating (step S201). The CPU 16a then energizes the solenoids assigned to the path selectors 13 and 14 (step S202) to thereby move the path selectors 13 and 14 counterclockwise and clockwise, respectively. Subsequently, the CPU 16a checks the ON/OFF state of the inlet sensor 11a1 (steps S203 and S204) and the ON/OFF state of the shift outlet sensor 15a3 (steps S205 and S206) to thereby confirm the passage of the sheets S.

On the elapse of a preselected period of time since the passage of the last sheet S (YES, step S207), the CPU 16a causes the various rollers mentioned above to stop rotating (S208) and deenergizes the solenoids (steps S209). In this manner, all the sheets S entered the finisher 10 are sequentially stacked on the shift tray 10c without being stapled. Again, the punch unit 10a, which intervenes between the inlet roller pair 11a2 and conveyor roller pair 11a3, may punch the consecutive sheets S.

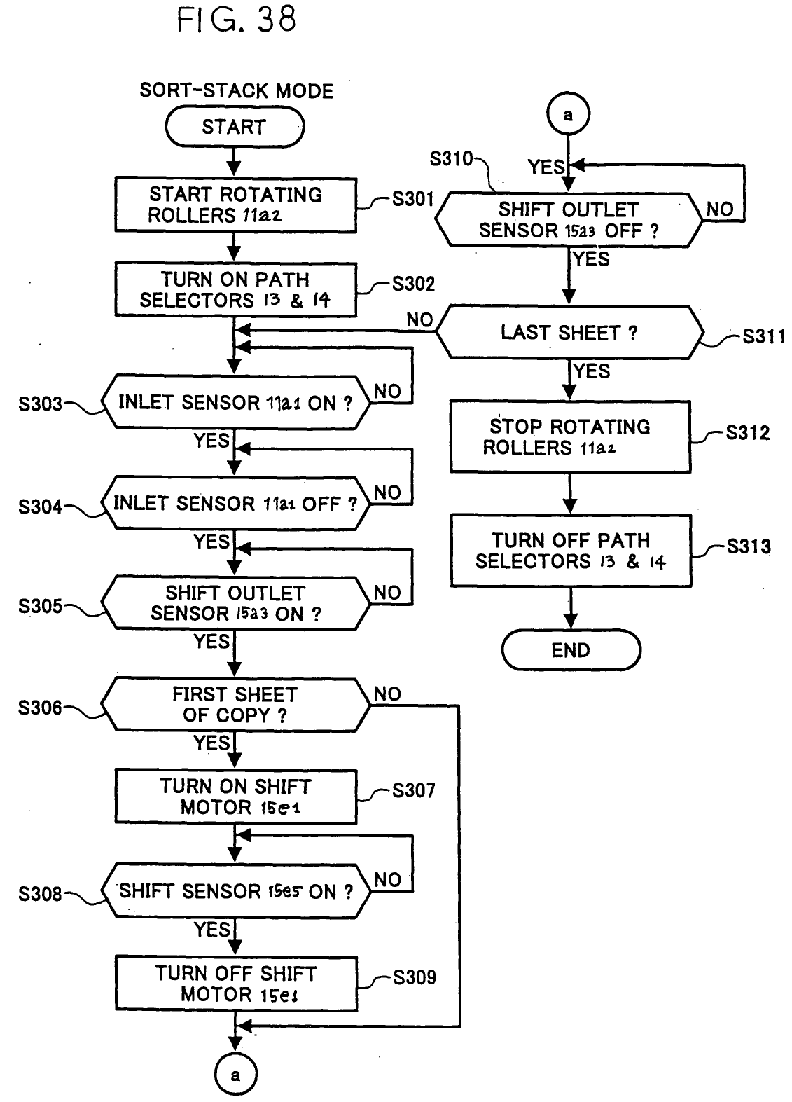

FIG. 38 demonstrates the sort/stack mode more specifically. As shown, before a sheet S driven out of the image forming apparatus 20 enters the finisher 10, the CPU 16a causes the inlet roller pair 11a2 and conveyor roller pair 11a3 on the path 11a and the conveyor roller pair 11c1 5 and shift outlet roller pair 15a on the path 11c to start rotating (step S301). The CPU 16a then energizes the solenoids assigned to the path selectors 13 and 14 (step S302) to thereby move the path selectors 13 and 14 counterclockwise and clockwise, respectively. Subsequently, the CPU 16a checks the ON/OFF state of the inlet sensor 11a1 (steps S303 and S304) and the ON/OFF state of the shift outlet sensor 15a3 (step S305)

If the sheet S passed the shift outlet sensor 15a3 is not the first sheet of a copy (NO, step S306), meaning that the shift tray 10c has already moved, then the CPU 16a causes the sheet S to be directly driven out (step S310). If the answer of the step S306 is YES, meaning that the sheet S is the first sheet of a copy, then the CPU 16a turns on the shift motor 15e1 (step S307) to thereby move the shift tray 10c perpendicularly to the direction of sheet conveyance until the shift sensor 16e5 senses the tray 10c (steps S308). When the shift sensor 15e5 senses the shift tray 10c, the CPU 15a turns off the shift motor 15e1 (step S309) and causes the sheet S to be driven out to the shift tray 10c.

Subsequently, the CPU 16a determines whether or not the shift outlet sensor 15a is in an OFF state (step S310). The CPU 10a then determines whether or not the sheet S is the last sheet (step S311). If the answer of the step S311 is NO, meaning that the sheet is not the last sheet of a copy, then the procedure returns to the step S303. If the answer of the step S311 is YES, then the CPU 16A causes the inlet roller pair 11a2 and conveyor roller pair 11a3 on the path 11a and the roller pair 11c1 and shift outlet roller pair 15a on the path 11c to stop rotating (step S312). Thereafter, the CPU 16a deenergizes the solenoids assigned to the path selectors 13 and 14 (step S313) and then ends the procedure.

In this manner, all the sheets sequentially entered the finisher 20 are sorted and stacked on the shift tray 10c without being stapled. In this mode, too, the punch unit 100 may punch the consecutive sheets, if desired.

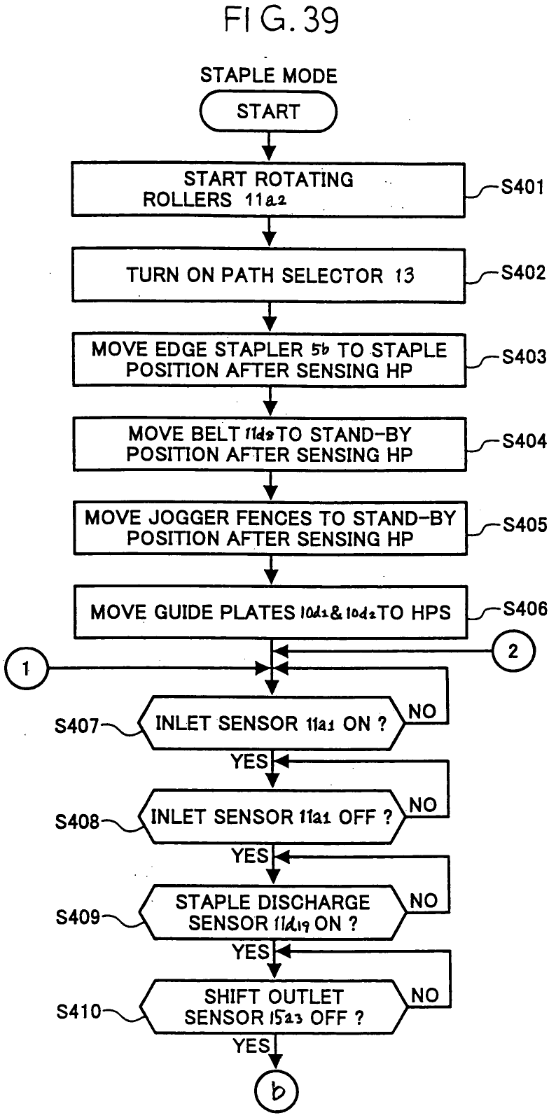

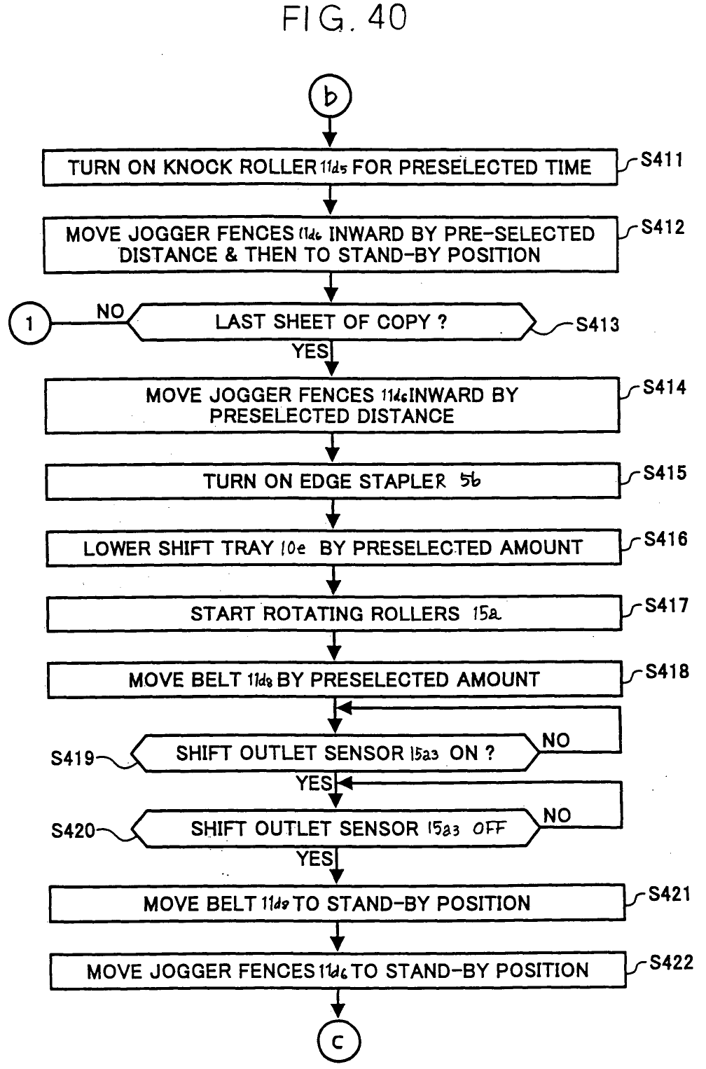

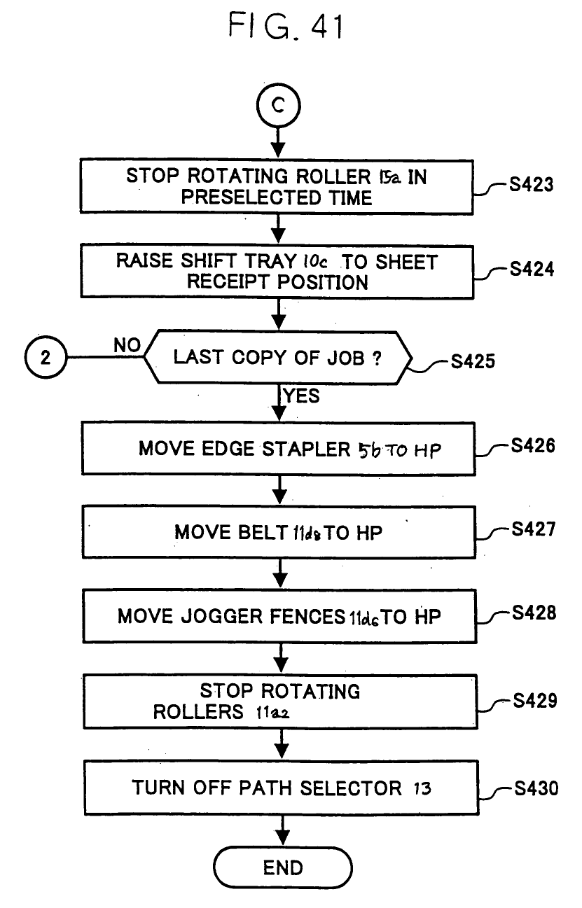

Reference will be made to FIGS. 39 through 41 for describing the staple mode. As shown, before a sheet S driven out of the image forming apparatus 20 enters the finisher 10, the CPU 16a causes the inlet roller pair 11a2 and conveyor roller pair 11a3 on the path 1, the conveyor roller pairs 11d18, 11d2, 11d3 and staple outlet roller 11d4 on the path 11d and knock roller 11d5 to start rotating (step S401). The CPU 16a then energizes the solenoid assigned to the path selector 13 (step S402) to thereby cause the path selector 13 to rotate counterclockwise.

After the stapler HP sensor 11d17 has sensed the edge stapler 5b at the home position, the CPU 16a drives the stapler motor 11d15 to move the edge stapler 5b to a preselected stapling position (step S403). Also, after the belt HP sensor 11d9 has sensed the belt 11d8 at the home position, the CPU 10a drives the discharge motor 11d10 to bring the belt 11d8 to a stand-by position (step S404). Further, after the jogger fence motor HP sensor has sensed the jogger fences 11d6 at the home position, the CPU 16amoves the jogger fences 1d6 to a stand-by position (step S405) In addition, the CPU 16a causes the guide plate 10d1 and movable guide 10d2 to move to their home positions (step S406).

If the inlet sensor 11a1 has turned on (YES, step S407) and then turned off (YES, step S408), if the staple discharge sensor 11d19 has turned on (YES, step S409) and if the shift outlet sensor 15a3 has tuned on (YES, step S410), then the CPU 16a determines that a sheet S is present on the staple tray 10d. In this case, the CPU 16a energizes the knock solenoid 1d52 for a preselected period of time to cause the knock roller 11d5 to contact the sheet S and force it against the rear fences 10d3, thereby positioning the rear edge of the sheet S (step S411). Subsequently, the CPU 16a drives the jogger motor 11d61 to move each jogger fence 11d6 inward by a preselected distance for thereby positioning the sheet S in the direction of width perpendicular to the direction of sheet conveyance and then returns the jogger fence 11d6 to the stand-by position (step S412). The CPU 16a repeats the step S407 and successive steps with every sheet. When the last sheet S of a copy arrives at the staple tray 10d (YES, step S413), the CPU 16a moves the jogger fences 11d6 inward to a position where they prevent the edges of the sheets from being dislocated (step S414). In this condition, the CPU 16a turns on the stapler 5b and causes it to staple the edge of the sheet stack (step S415).

On the other hand, the CPU 16a lowers the shift tray 10c by a preselected amount (step S416) in order to produce a space for receiving the stapled sheet stack. The CPU 16a then drives the shift discharge roller pair 15a via the shift discharge motor (step S417) and drives the belt 11d8 by a preselected amount via the discharge motor 11d10 (step S418), so that the stapled sheet stack is raised toward the path 11c. As a result, the stapled sheet stack is driven out to the shift tray 10c via the shift outlet roller pair 15a (S418). After the shift outlet sensor 303 has turned on (step S419) and then turned off (step S420), meaning that the sheet stack has moved away from the sensor 15a3, the CPU 16a moves the belt 11d8 and jogger fences 11d6 to their stand-by positions (steps S421 and S422), causes the shift outlet roller pair 15a to stop rotating on the elapse of a preselected period of time (step S423), and raises the shift tray 10c to a sheet receiving position (step S424). The rise of the shift tray 10c is controlled in accordance with the output of the sheet surface sensor 15c responsive to the top of the sheet stack positioned on the shift tray 10c.

After the last copy or set of sheets has been driven out to the shift tray 10c, the CPU 16a returns the edge stapler 5b, belt 11d8 and jogger fences 11d6 to their home positions (steps S426, S427 and S428) and causes the inlet roller pair 11a2, conveyor roller pairs 11a3, 11d18, 11d2, 11d3 and 11d4 and knock roller 11d5 to stop rotating (step S429). Further, the CPU 16a deenergizes the solenoid assigned to the path selector 13 (step S430). Consequently, all the structural parts are returned to their initial positions. In this case, too, the punch unit 10a may punch the consecutive sheets before stapling.

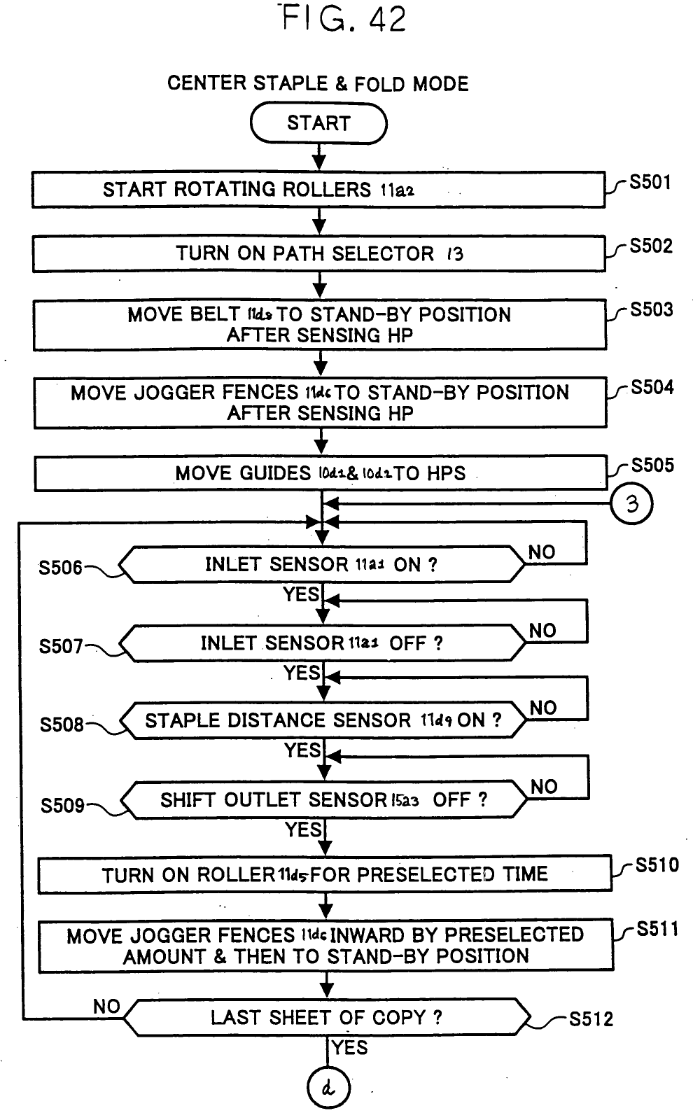

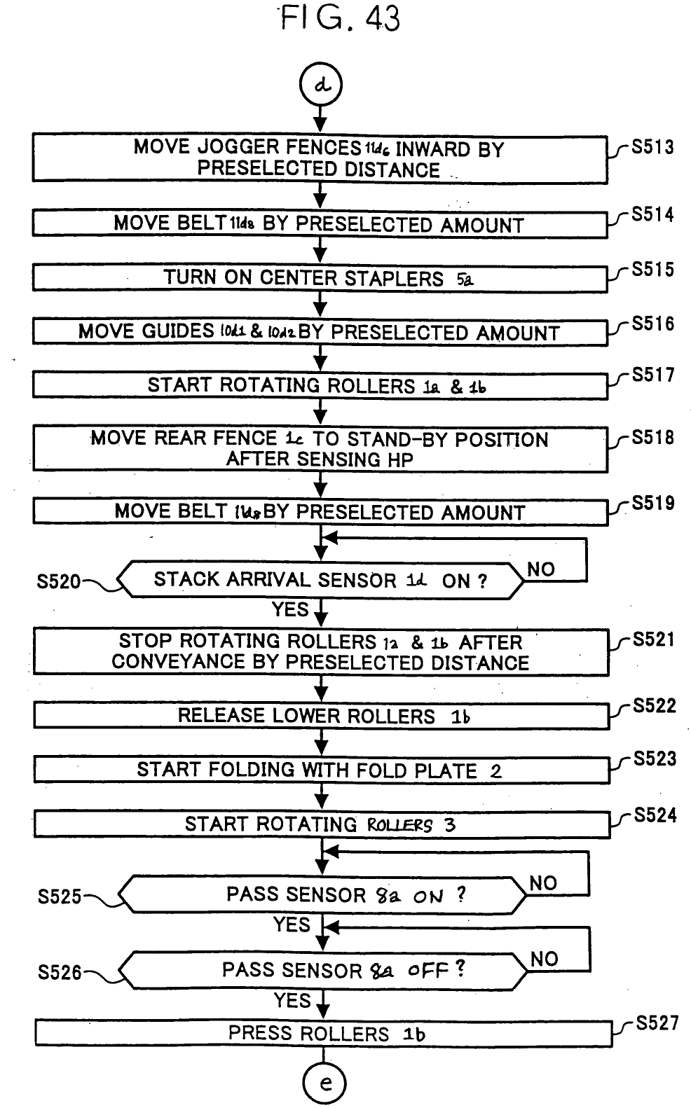

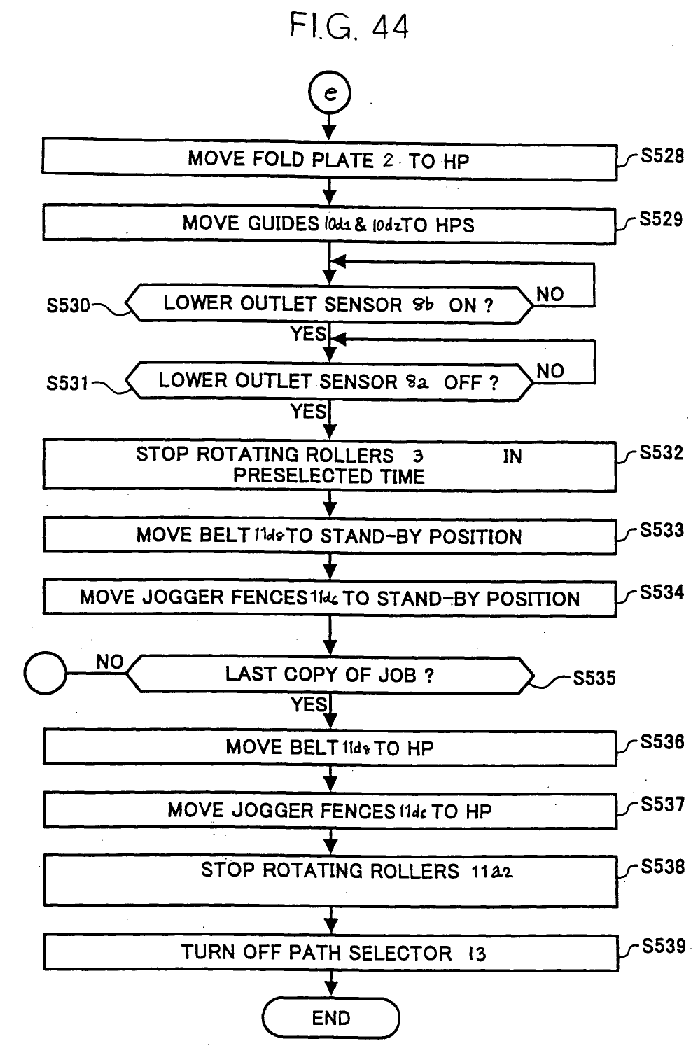

Reference will be made to FIGS. 42 through 44 for describing the center staple and bind mode available with the illustrative embodiment more specifically. As shown, before a sheet driven out of the image forming apparatus 20 enters the finisher 10, CPU 16a causes the inlet roller pair 11a2 and conveyor roller pair 11a3 on the path 11a, the conveyor roller pairs 11d18, 11d2 and 11d3 and staple outlet roller 11d4 on the path 11d and knock roller 11d5 to start rotating (step S501). The CPU 16a then energizes the solenoid assigned to the path selector 13 (step S502) to thereby cause the path selector 13 to rotate counterclockwise.

Subsequently, after the belt sensor 11d9 has sensed the belt 11d8 at the home position, the CPU 16a drives the discharge motor 11d10 to move the belt 11d8 to the stand-by position (step S503). Also, after the jogger fence HP sensor has sensed each jogger fence 11d6 at the home position, the CPU 16a moves the jogger fence to the stand-by position (step S504). Further, the CPU 16a moves the guide plate 10d1 and movable guide 10d2 to their home positions (steps S505).

If the inlet sensor 11a1 has turned on (YES, step S506) and then turned off (YES, step S507), if the staple discharge sensor 11d19 has turned on (YES, step S508) and if the shift outlet sensor 15a3 has tuned on (YES, step S509), then the CPU 16a determines that a sheet S is present on the staple tray 10d. In this case, the CPU 16a energizes the knock solenoid 11d52 for the preselected period of time to cause the knock roller 11d5 to contact the sheet and force it against the rear fences 10d3, thereby positioning the trailing edge of the sheet (step S510). Subsequently, the CPU 16a drives the jogger motor 11d61 to move each jogger fence 11d6 inward by the preselected distance for thereby positioning the sheet in the direction of width perpendicular to the direction of sheet conveyance and then returns the jogger fence 11d6 to the stand-by position (step S511). The CPU 16a repeats the steps S506 through S512 with every sheet. When the last sheet of a copy arrives at the staple tray 10d (YES, step S512), the CPU 16a moves the jogger fences 11d6 inward to the position where they prevent the edges of the sheets from being dislocated (step S513).

After the step S513, the CPU 16a turns on the discharge motor 11d10 to thereby move the belt 11d8 by a preselected amount (step S514), so that the belt 11d8 lifts the sheet stack to a stapling position assigned to the center staplers 5a. Subsequently, the CPU 16a turns on the center staplers 5a at the intermediate portion of the sheet stack for thereby stapling the sheet stack at the center (step S515). The CPU 16a then moves the guides 10d1 and 10d2 by a preselected amount each in order to form a path directed toward the path 1 of the folding device 0 (step S516) and causes the upper and lower roller pairs 1a and 1b on the path 1 to start rotating (step S517). As soon as the movable rear fence 1c on the path 1 is sensed at the home position, the CPU 16a moves the fence 1c to a stand-by position (step S518). The path 1 is now ready to receive the stapled sheet stack.

After the step S518, the CPU 16a further moves the belt 11d8 by a preselected amount (step S519) and causes the discharge roller 11d13 and press roller 10d12 to nip the sheet stack and convey it to the path 1. After the leading edge of the stapled sheet stack has arrived at the stack arrival sensor 1d (step S520), the CPU 16a causes the upper and lower roller pairs 1a and 1b on the path 1 to stop rotating (step S521), causes the fold plate 2 to starts moving for folding the sheet stack (step S523), and causes the fold roller pairs 3 and 6 and lower outlet roller pair 12a to start rotating (step S524). The CPU 16a then determines whether or not the pass sensor 8a responsive to the folded sheet stack has turned on (YES, step S525) and then turned off (YES, step S526). The CPU 16a then brings the lower rollers 1b into contact (step S527) and moves the fold plate 2 and guides 10d1 and 10d2 to their home positions (steps S528 and S529).

In the above condition, the CPU 16a determines whether or not the trailing edge of the folded sheet stack has moved away from the lower outlet sensor 8b (steps S530 and S531). If the answer of the step S531 is YES, then the CPU 16a causes the fold roller pairs 3 and 6 and lower outlet roller pair 12a to further rotate for a preselected period of time and then stop (step S532) and then causes the belt 11d8 and jogger fences 11d6 to return to the stand-by positions (steps S533 and S534). Subsequently, the CPU 16a determines whether or not the above sheet stack is the last copy of a single job to perform (step S535) If the answer of the step S535 is NO, then the procedure returns to the step S506. If the answer of the step S535 is YES, then the CPU 16a returns the belt 11d8 and jogger fences 11d6 to the home positions (steps S536 and S537). At the same time, the CPU 16a causes the inlet roller pair 11a2, roller pairs 11a3, 11d18, 11d2, 11d3, 11d4 and knock roller 11d5 to stop rotating (step S538) and turns off the solenoid assigned to the path selector 13 (step S539). As a result, all the structural parts are returned to their initial positions.

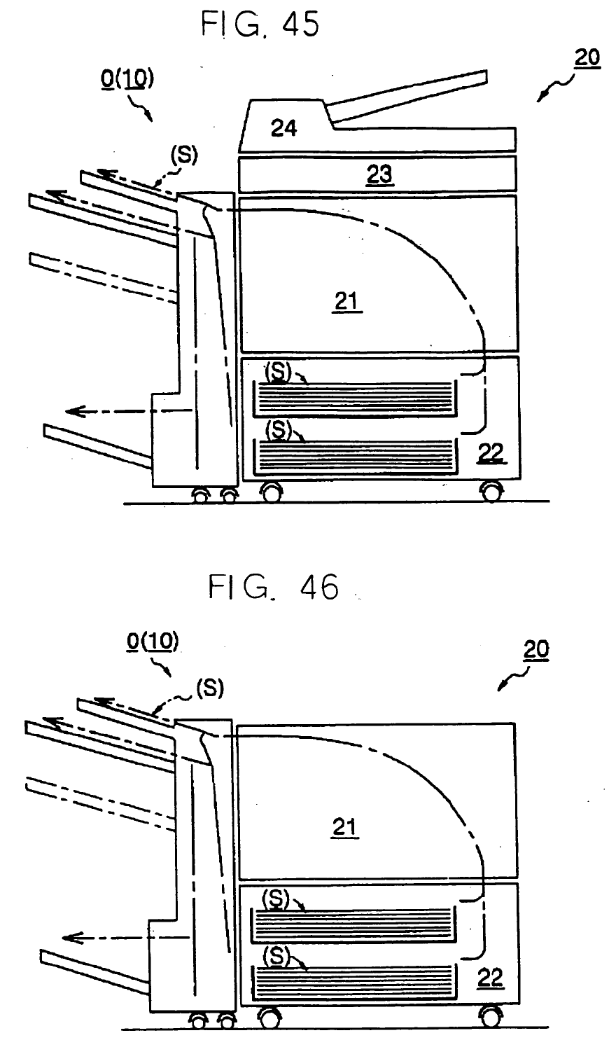

A specific configuration of the image forming apparatus 20 will be described with reference to FIGS. 45 through 47. As shown, the image forming apparatus includes toner image forming means 21, a sheet feeder 22 for feeding a sheet S to the toner image forming means 21, a scanner 23 for reading a document image, and an ADF (Automatic Document Feeder) 24. The sheet finisher 10 with the folding device 0 is operatively mounted to one side of the image forming apparatus.

In FIG. 45, the image forming apparatus is implemented as a copier by way of example. The sheet is usually conveyed from the sheet feeder 22 to the finisher 10 via the toner image forming means 21.

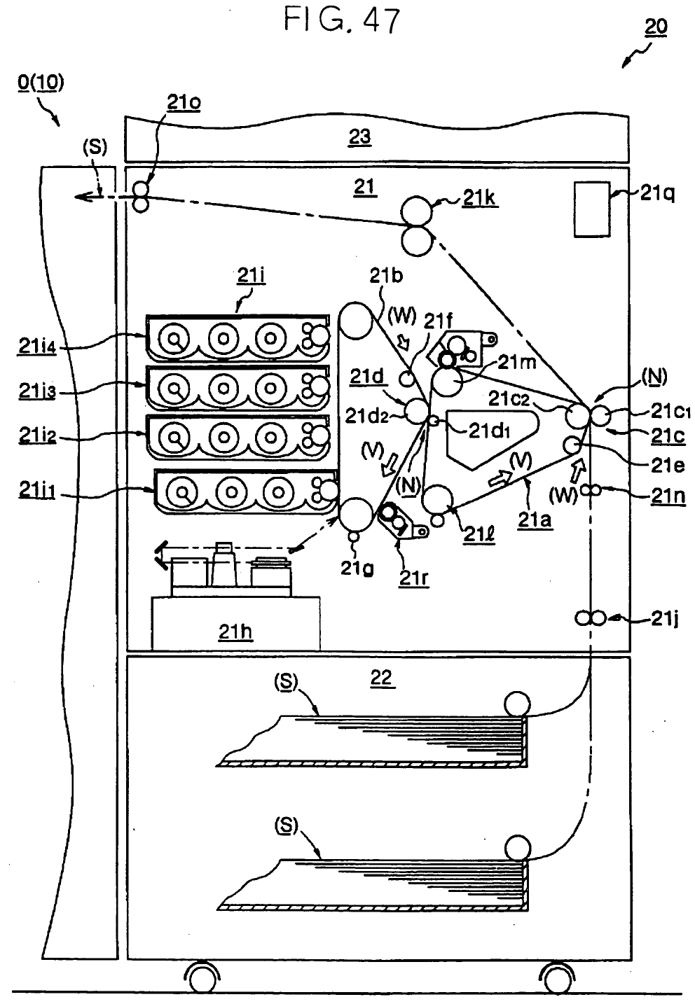

FIG. 46 shows an image forming system implemented as a printer in which the scanner 23 and ADF 24 are absent. The printer is identical with the copier of FIG. 45 as for the rest of the configuration.

As shown in FIG. 47 specifically, the toner image forming means 21 includes a photoconductive belt implemented as an intermediate image transfer belt 21a or a belt-like image carrier 21b. The intermediate image transfer belt 21a is an urethane-based elastic member. Image transferring means 21c or 21d transfers a toner image formed on the intermediate image transfer belt 21a or the image carrier 21b to the sheet S or the belt 21a, respectively. The intermediate image transfer belt 21a, movable in a direction V via the nip of the image transferring means 21c, is passed over a tension roller 21e, a drive roller 21l, and a roller 21m. Likewise, the image carrier 21b, movable in a direction V via the nip N of the image transferring means 21d, is passed over a tension roller 21f as well as other rollers. The tension rollers 21e and 21f are respectively positioned upstream of the image transferring means 21c and 21d in a direction W in which the belts 21a and 21b enter the associated nips N. Also included in the image forming means 21 are a charger 21g, an optical writing unit 21h, developing units 21i1 through 21i4, collectively 21i, a roller pair 21j for sheet conveyance, a fixing unit 21k, a registration roller pair 21n, an outlet roller pair 20o, the operation panel 21q, and a cleaning unit 21r.

The image transferring means 21c is made up of rollers 21c1 and 21c2 while the image transferring means 21d is made up of rollers 21d1 and 21d2.

Arranged around the belt-like image carrier (belt hereinafter) 21b are the charger 21g, the optical writing unit 21h, developing devices 21i1 through 21i4, intermediate image transfer belt 21a and cleaning unit 21r. The developing units 21i1 through 21i4 are respectively assigned to black (B), cyan (C), magenta (M) and yellow (Y), respectively. The belt 21b has an organic photoconductive layer formed thereon.

In operation, when a start switch, not shown, provided on the operation panel 21q is pressed, a high voltage is applied to the charger 21g to thereby uniformly charge the surface of the belt 21b. A signal processor, not shown, converts color image information, e.g., color image signals input from a computer to corresponding color image data and sends the color image data to the optical writing unit 21h.

In the optical writing unit 21h, lasers are controlled in accordance with the color image data. Laser beams, issuing from the lasers, are routed through a polygonal mirror, an fθ lens and mirrors although not shown specifically. As a result, latent images are sequentially formed on the belt 21b in accordance with the B, C, M and Y image data.

The developing units 21i1 through 21i4 sequentially develop the latent images formed on the belt 21b with B, C, M and Y toners to thereby produce B, C, M and Y toner images respectively. At the position where the belt 21b contact the intermediate image transfer belt 21a, a charge opposite in polarity to the toners is applied in order to transfer the toner images from the belt 21b to the belt 21a one above the other, completing a full-color toner image.

Subsequently, the full-color toner image is transferred from the intermediate image transfer belt to the sheet S fed from the sheet feeder 22 via the roller pair 21j and registration roller pair 21n by the image transferring means or secondary image transfer member 21c. The image transferring means 21 is implemented by simple rollers 21c1 and 21c2, as stated earlier.

The sheet S, carrying the full-color toner image thereon, is conveyed to the fixing unit 21k to have the toner image fixed thereby. The sheet S is then handed over from the image forming apparatus 20 to the sheet finisher 10 via the outlet roller pair 21o.

The rollers 21l, 21m and 21c2 and other rollers except for the tension roller 21e are fixed in position relative to the frame of an intermediate image transferring unit.

As stated above, the illustrative embodiment is capable of surely, easily folding a sheet stack with a simple fold roller pair at an adequate position, providing the sheet stack with a sharp, attractive fold. It follows that a plurality of folded sheet stacks can be neatly stacked without collapsing. Particularly, pressing forces, exerted by two fold rollers, are well balanced with each other.

Further, even when the nip of the fold roller pair is shifted from the line L including the locus of movement of the fold plate 2 after the assembly of the folding device, the shift can be immediately corrected.

### Second Embodiment

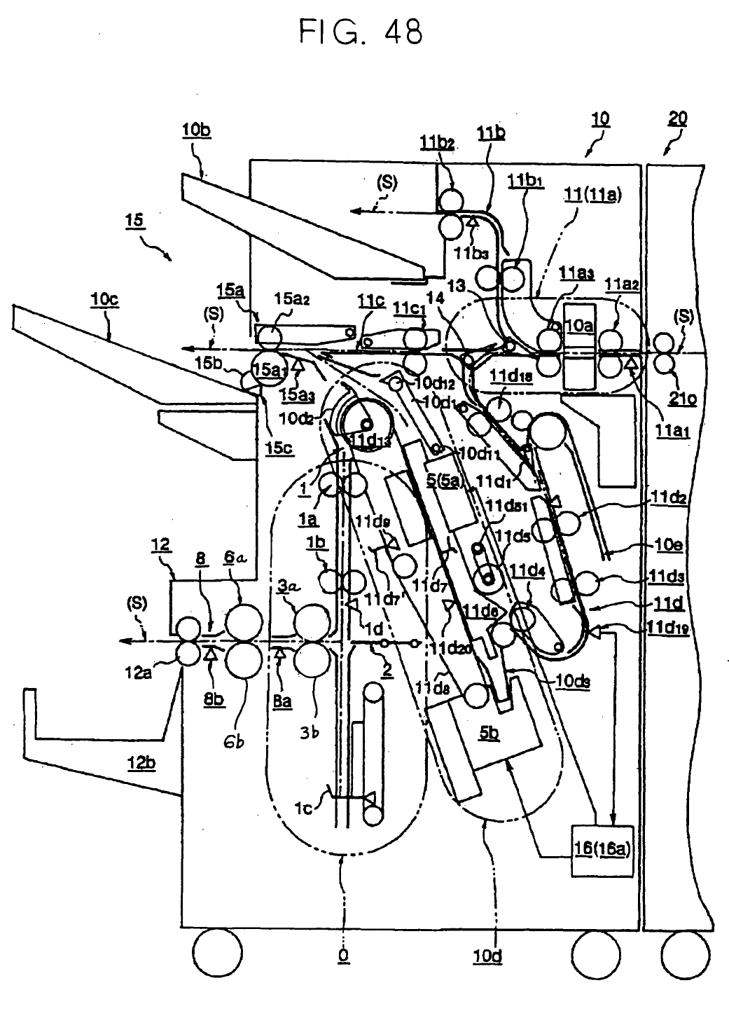

A second embodiment of the present invention will be described hereinafter. The description of the first embodiment made with reference to FIGS. 7 through 35 and 42 through 43 also apply to the second embodiment. The following description will therefore concentrate on differences between the first and second embodiments. FIG. 48 shows a sheet finisher 10 of the illustrative embodiment identical with the sheet finisher 10 of the previous embodiment except for the following.

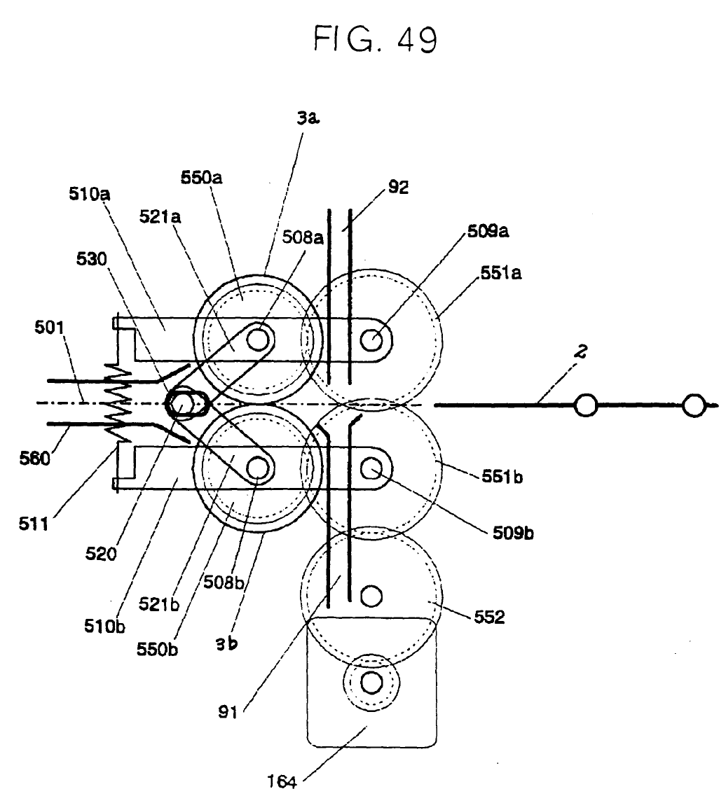

FIG. 49 shows a mechanism for driving the fold rollers 3a and 3b. As shown, press bars 510a and 510b are respectively angularly movably supported by shafts 509a and 509b at one end and constantly biased toward each other by a tension spring 511 at the other end. Further, the press bars 510a and 510b are respectively supported by roller shafts 508a and 508b at the intermediate portions thereof. The roller shafts 508a and 508b are connected to a movable shaft 520, which is movable on the extension 501 of the locus of movement of the fold plate 2, by links or connecting means 521a and 521b, respectively. Although the extension of the above locus is indicated by a dash-and-dot line, it is, in practice, a plane.

In the above configuration, the press bars 510a and 510b are angulaly movable substantially symmetrically to each other with respect to the extension 501 of the locus. The movable shaft 520 moves back and forth along the extension 501 in accordance with the movement of the press bars 510a and 510b. The movable shaft 520 is received in a slot 530 and movable within the lengthwise range of the slot 530, determining the maximum gap between the fold rollers 3a and 3b. A path 560, like the extension 501, is positioned at the center of the gap.

A gear 552 is held in mesh with the output shaft of a fold roller motor 164 and a gear 551b, which is, in turn, held in mesh with a gear 551a. The gears 551a and 551b are held in mesh with gears 550a and 550b, respectively. The output torque of the fold roller motor 164 is transferred to the fold rollers 3a and 3b via such a gear train, causing the fold rollers 3a and 3b to rotate at the same speed as each other.

The fold rollers 3a and 3b move away from each other symmetrically to the extension 501 in accordance with the thickness of a sheet stack, exerting a pressing force on the sheet stack up to the maximum distance due to the bias of the tension spring 511. More specifically, the ends of the press bars 510a and 510b to which the tension spring 511 is anchored move farther from each other as the thickness of the sheet stack increases, so that the force that folds the sheet stack increases. It is noteworthy that when the thickness of the folded sheet stack exceeds the maximum distance between the fold rollers 3a and 3b, the sheet stack cannot pass through the gap between the fold rollers 3a and 3b and is therefore prevented from jamming the path after entering the above gap. Further, even when the sheet stack is thick, the fold formed by the fold plate 2 and the fold formed by the fold rollers 3a and 3b accurately coincide with each other.

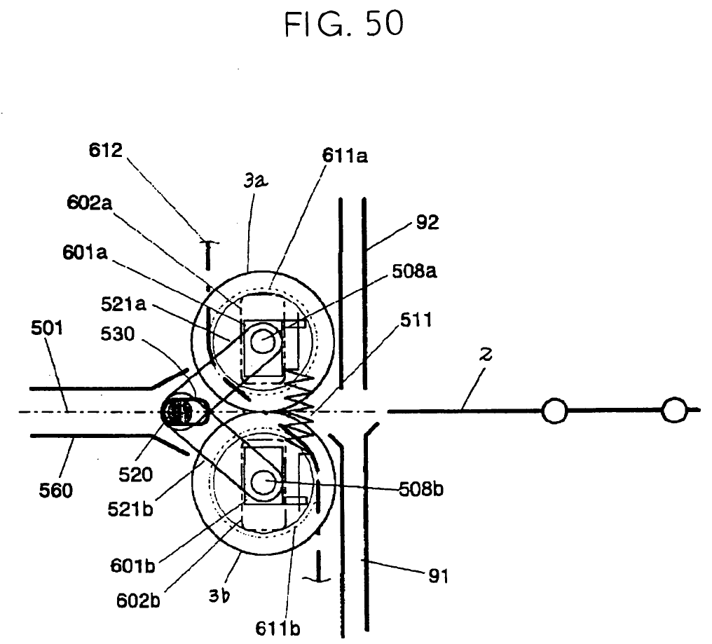

FIG. 50 shows a modified mechanism for driving the fold rollers 3a and 3b. As shown, the press bars 510a and 510b, FIG. 49, are replaced with guides 602a and 602b positioned perpendicularly to the extension 501 and slide bearings 601a and 601b linearly movable along the guides 602a and 602b. In this modification, the tension spring 511 constantly biases the slide bearings 601a and 601b toward each other.

Timing pulleys 508a and 508b are mounted on the shafts 508a and 508b, respectively, while a timing belt 612 are passed over the timing pulleys 508a and 508b, as illustrated. In this configuration, the fold rollers 3a and 3b are driven to fold a sheet stack.

The drive mechanism shown in FIG. 49 or 50 is similarly applicable to the other fold rollers or reinforce rollers 6a and 6b, FIG. 48, so that the fold of a sheet stack can be reinforced with its fold coinciding with the stapled position. At this instant, the nip between the fold rollers 6a and 6b is also positioned on the extension 501 of the locus of the fold plate 2, so that the path 560 following the fold rollers 6a and 6b has the extension 501 located at the center of the gap.

As stated above, in the illustrative embodiment, a sheet stack is conveyed while being pressed without its center being shifted relative to the fold rollers 3a and 3b without regard to the number of sheets. Therefore, the fold of the sheet stack formed by the fold rollers 3a and 3b accurately coincides with the stapled position of the same. Further, the link mechanism, which generally withstands heavy loads and can be easily provided with dimensional accuracy, allows a sheet stack to be accurately, sharply folded without the pressing force being limited.

Further, because the movable range of the movable shaft 520 is limited by the slot 530, the displacement of the fold rollers 3a and 3b is limited such that the maximum gap between the rollers 3a and 3b is smaller than or equal to the gap preceding or following it. This insures smooth conveyance of a sheet stack while reducing noise ascribable to conveyance.

Moreover, the nip between the fold rollers or reinforce rollers 6a and 6b is accurately coincident with the fold of a sheet stack formed by the fold rollers 3a and 3b.

### Third Embodiment

A third embodiment of the present invention will be described hereinafter. The description of the first embodiment made with reference to FIGS. 7 through 42 also apply to the third embodiment. The following description will therefore concentrate on differences between the first and third embodiments.

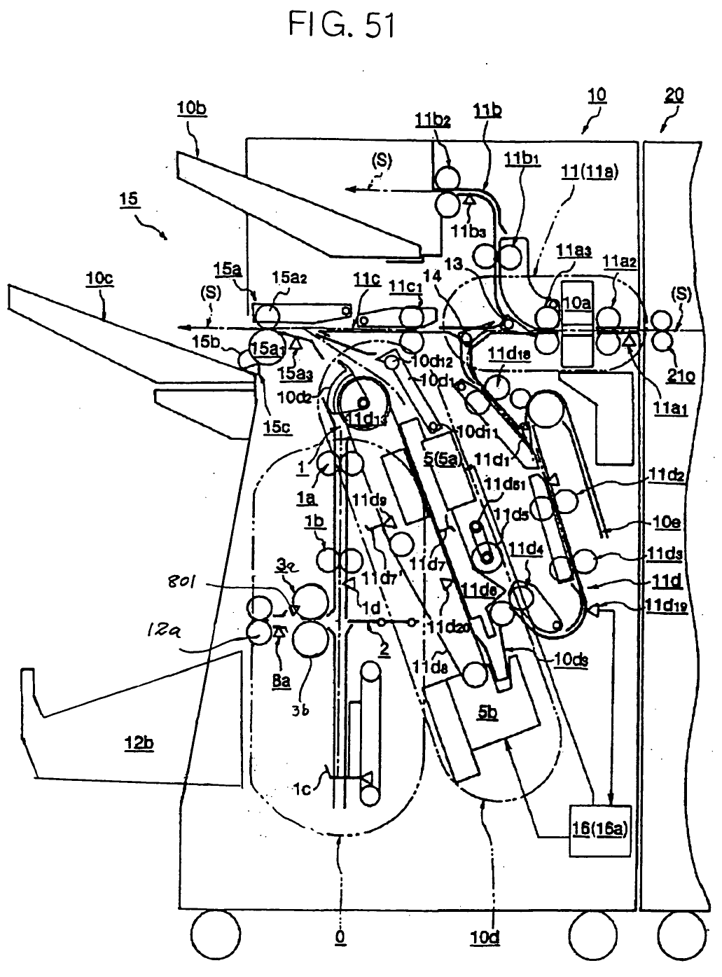

FIG. 51 shows a sheet finisher to which the illustrative embodiment is applied. As shown, the sheet finisher is generally identical with the sheet finisher 10 of the first embodiment, FIG. 6, except for the sheet folding device 0.

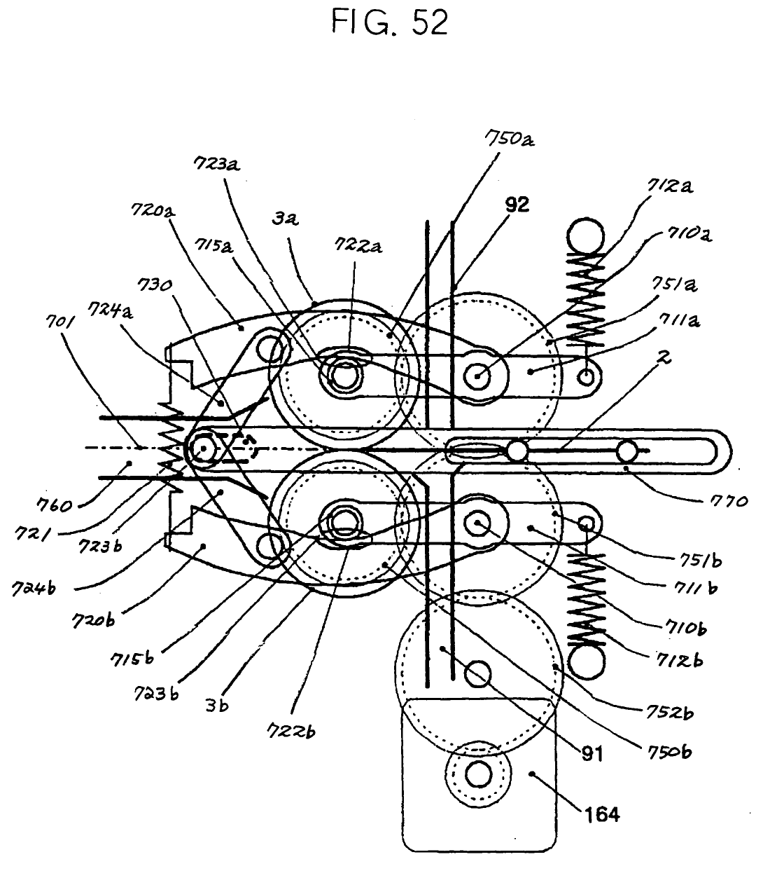

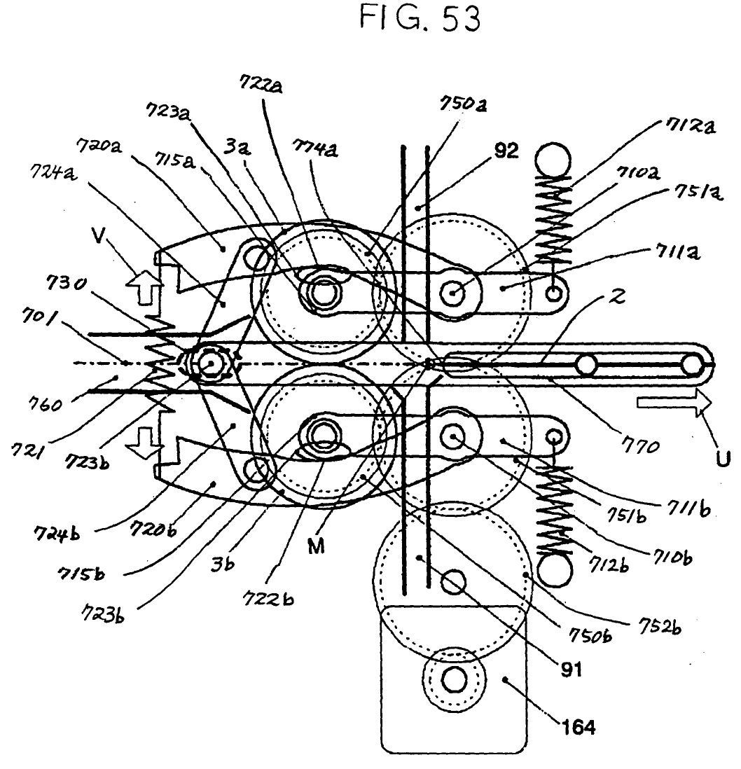

FIGS. 52 and 53 show the sheet folding device 0, particularly a mechanism for selectively applying pressure to the fold rollers 3a and 3b or canceling it, in detail. As shown, the pressure applying and canceling mechanism includes the fold rollers 3a and 3b, movable arms or first members 711a and 711b, swing arms or second members 720a and 720b, tie bars or third members 724a and 724b, first springs 712a and 712b, a second spring 721, the fold plate 2, a pressure cancel link (or third member) 770, and the motor 164 for driving the fold rollers 3a and 3b. The nip between the fold rollers 3a and 3b is positioned on a line 701 including the locus of movement 701 of the fold plate 2. Because various members are arranged substantially symmetrically with respect to the line 701, the members above the line 701 and the members below the line 701 are distinguished from each other by suffices a and b, respectively.

The movable arms 711a and 711b are respectively angularly movably supported by fulcrums 710a and 710b, which are, in turn, supported by the opposite side walls supporting the various portions of the fold tray. The fold rollers 3a and 3b are respectively rotatably supported by the movable arms 711a and 711b via bearings 715a and 715b. The second springs 712a and 712b are respectively anchored to the upstream ends of the movable arms 711a and 711b in the direction of sheet conveyance, constantly pressing the fold rollers 3a and 3b against each other. The second springs 712a and 712b exert a bias that implements a force necessary for the fold rollers 3a and 3b to convey a sheet stack. The movable arms 711a and 711b, fulcrums 710a and 710b, swing arms 720a and 720b and first and second springs 721, 712a and 712b each are provided in a pair at the inside and outside of the opposite side walls. The axes of the fold rollers 3a and 3b extend in the direction perpendicular to the sheet surface of FIG. 52 or 53.

The swing arms 720a and 720b, like the movable arms 711a and 711b, are respectively swingably supported by the fulcrums 710a and 710b at the upstream ends thereof in the direction of sheet conveyance. The second spring 721 is anchored to the swing arms 720a and 720b at opposite ends thereof, constantly biasing the above ends toward each other. As shown in FIG. 52, the swing arms 720a and 720b are respectively positioned above and below the fold rollers 3a and 3b. When the bearings 715a and 715b of the fold rollers 3a and 3b are moved away from each other by a preselected distance, the fold rollers 3a and 3b respectively contact the edges of the swing arms 720a and 720b facing each other and are therefore subject to the bias of the second spring 721.

So long as the bearings 715a and 715b do not contact the swing arms 720a and 720b, respectively, the fold rollers 3a and 3b are subject to the bias of the first springs 712a and 712b, respectively. The bias of the second spring 721 is selected to be stronger than the bias of the first springs 712a and 712b. In this configuration, when a sheet stack enters the nip between the fold rollers 3a and 3b, the comparatively weak bias of the first springs 712a and 712b acts on the sheet stack. When the bearings 715a and 715b respectively contact the swing arms 720a and 720b, the comparatively strong bias of the second spring 721 acts on the sheet stack. In this configuration, gaps or plays 723a and 723b between the positions where the fold rollers 3a and 3b contact each other and the positions where the bearings 715a and 715b contact the swing arms 720a and 720b play an important role when a sheet stack enters the nip between the fold rollers 3a and 3b.

To provide the fold rollers 3a and 3b with a conveying function in addition to the folding function, the illustrative embodiment additionally includes the motor 164 and drive transmission mechanism. The drive transmission mechanism is implemented as a speed reduction gear train including gears 752, 751a and 751b. The gear 752 is held in mesh with the output shaft of the motor 164 and the gear 751b, which is held in mesh with the gear 751a. The gears 751a and 751b are respectively held in mesh with gears 750a and 750b, which are coaxial with the fold rollers 3a and 3b, and rotated at the same speed.

The pressure cancel link 770 is positioned at the inside of each of the opposite side walls and movable back and forth along the line in interlocked relation to the fold plate 2. The pressure cancel link 770 limits the positions of the swing arms 720a and 720b for thereby canceling pressure acting on the fold rollers 3a and 3b. More specifically, the tie bars 724a and 724b respectively connect a movable shaft 723, which is positioned downstream of the fold rollers 3a and 3b in the direction of sheet conveyance, and swing arms 720a and 720b, thereby relating the position of the pressure cancel link 770 and the positions of the swing arms 720a and 720b. In this configuration, the position of the pressure cancel link 770 determines the timing for applying the pressure to a sheet stack and the timing for canceling it.

The movable shaft 723 is received in a guide slot 730 extending along the line 701, so that the dimension of the guide slot 730 determines the movable range of the shaft 723. The movable range of the shaft 723, in turn, determines the maximum gap between the fold rollers 3a and 3b. A path 760 along which a folded sheet stack is conveyed is positioned at the center of the above gap. The guide hole 730, determining the movable range of the shaft 723, may be replaced with slots formed in the swing arms 720a and 720b and receiving members provided on the tie bars 724a and 724b.

In the above configuration, the movement of the movable shaft 720 in the direction of sheet discharge is limited by the dimension of the guide hole 730, so that the gaps or plays 723a and 723b are guaranteed between the swing arms 720a and 720b and the bearings 715a and 715b. This successfully limits the transfer of the bias of the first springs 712a and 712b to the fold rollers 3a and 3b.

The first springs 712a and 712b may be replaced with compression springs positioned in portions 722a and 722b where the swing arms 720a and 720b press the fold rollers 3a and 3b, respectively, exerting a weak bias on the fold rollers 3a and 3b. The dimension of each gap 723a or 723b is determined by the position of the downstream end of the guide slot 730 in the direction of sheet conveyance. Therefore, the gaps 723a and 723b and the maximum gap between the fold rollers 3a and 3b are determined by the position of the guide slot 730 and the dimension of the pressure cancel link 770 in the direction of movement.

Further, the movable shaft 723 is operatively connected to the pressure cancel link 770. Therefore, when the pressure cancel link 770 is moved in a direction indicated by an arrow Y in FIG. 53, the swing arms 720a and 720b each are moved in a direction indicated by an arrow V. As a result, gaps are formed between the swing arms 720a and 720b and the bearings 715a and 715b, interrupting the transfer of the bias of the second spring 721.

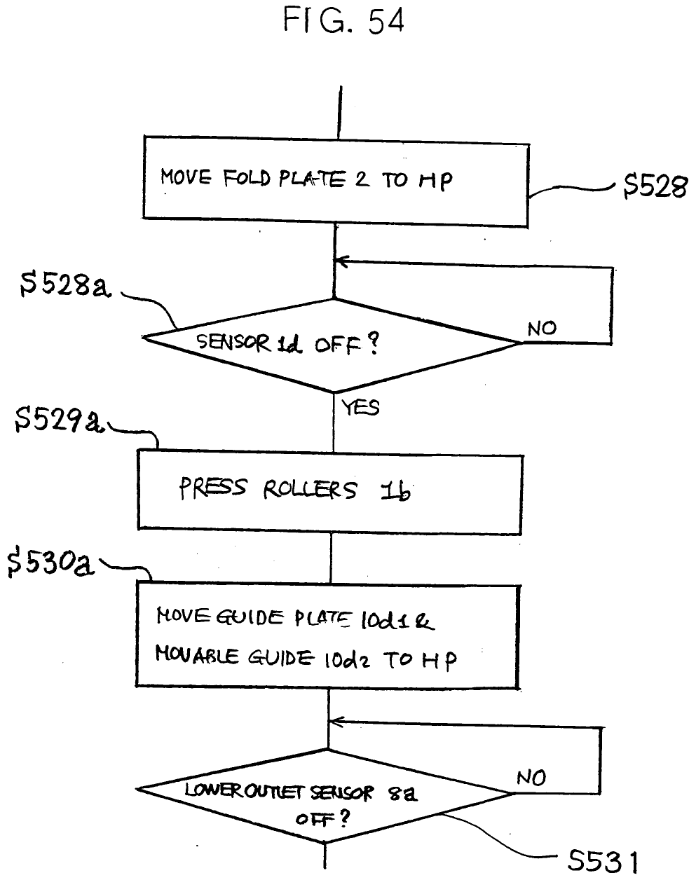

The center staple and bind mode available with the illustrative embodiment will be described with reference to FIG. 54 as well as to FIGS. 42 through 44. The center staple and bind mode of the illustrative embodiment is identical with the corresponding mode of the first embodiment described with reference to FIGS. 42 through 44 except for the following. In the illustrative embodiment, among the steps S501 through S528, the steps S526 and S527 are absent while, among the steps S529 through S539, the steps S531 through S534 are identical. Further, the steps S529 and S530 are replaced with steps S528a, S529a and S530a shown in FIG. 54.

As shown in FIG. 54, in the step S528, the CPU 16a causes the fold plate 2 to move to its home position. When the arrival sensor 1d turns off (YES, step S528a), the CPU 61a causes the lower roller pair 1b to be pressed (step S529a and causes the guide plate 10d1 and movable guide 10d2 to move to their home positions (step S5230a).

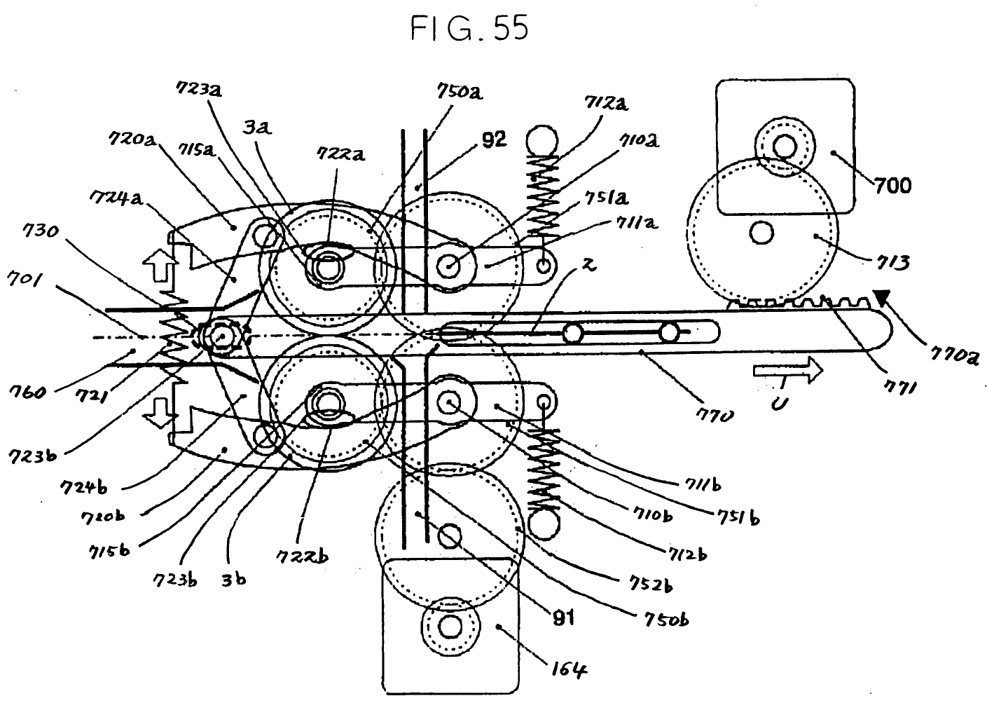

FIG. 55 shows a first modification of the illustrative embodiment shown in FIGS. 52 and 53. As shown, the pressure cancel link 770 is provided with a rack 771. A gear 713 is held in mesh with the rack 771 for retracting the pressure cancel link 770 in the direction U when the pressure should be canceled. The gear 713 is held in mesh with the output shaft of a pressure cancel motor 700. A link HP sensor 770a is responsive to the home position of the pressure cancel link 770. The pressure cancel motor 700 stops rotating as soon as the sensor 770a senses the pressure cancel link 770 returned to the home position. As for the rest of the configuration, the first modification is identical with the illustrative embodiment.

In the illustrative embodiment, the pressure cancel link 770 moves back and forth in interlocked relation to the fold plate 2. As soon as the pressure cancel link 770 retracts to a preselected position, the tie bars 724a and 724b move the swing arms 720a and 720b away from each other for thereby interrupting the transfer of the bias of the second spring 721 to the fold rollers 3a and 3b. By contrast, in the first modification described above, the pressure cancel link 770 is caused to retract independently of the movement of the fold plate 2, canceling the pressure of the fold rollers 3a and 3b at preselected timing.

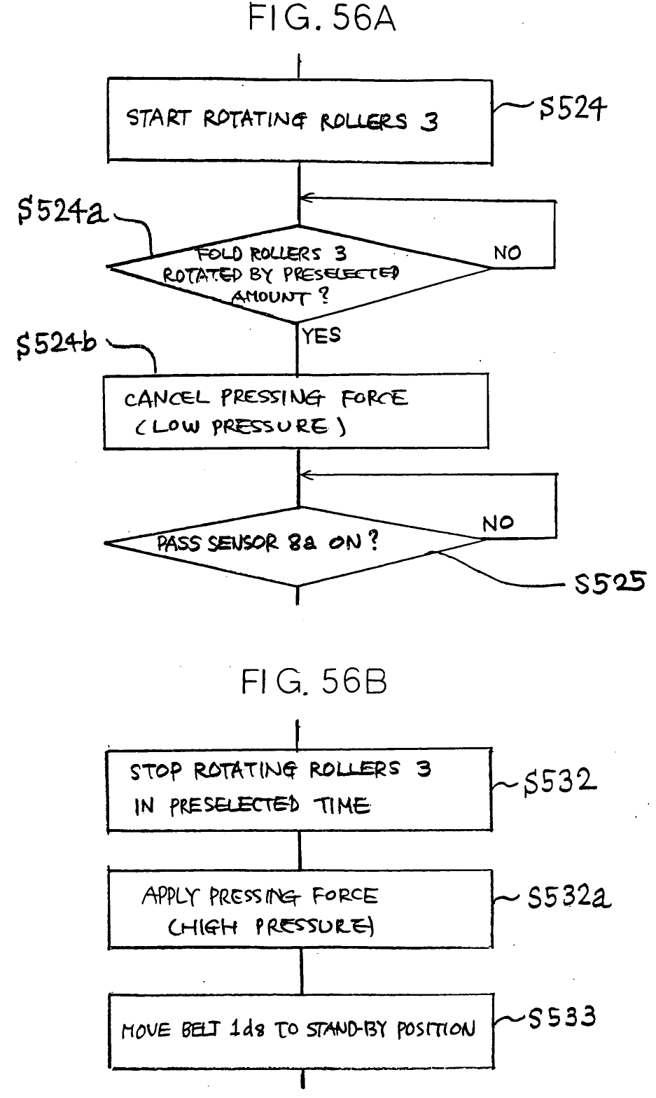

As shown in FIGS. 56A and 56B, as for the center staple and bind mode, the first modification is identical with the illustrative embodiment except that two steps S524a and 524b intervene between the steps S524 and S525 and that a step S532a intervenes between the steps S532 and S533.

More specifically, in the step S524 shown in FIG. 56A, the CPU 16a causes the fold rollers 3a and 3b and lower outlet roller 12a to start rotating. When the fold rollers 3a and 3b have rotated by an amount large enough to sufficiently fold the leading edge of the sheet stack (YES, step 524a), the CPU 16a causes the pressure cancel motor 700 to rotate to retract the pressure cancel link 770. Consequently, the movable shaft 723 moves, as stated earlier, with the result that the tie bars 724a and 724b open the swing arms 720a and 720b for thereby canceling the pressure acting on the fold rollers 3a and 3b (step S524b).

When the leading edge of the sheet stack moves away from the pass sensor 8a (YES S525), the CPU 16a returns the fold plate 2 to the home position, as shown in FIG. 54 (step S528). Subsequently, when the arrival sensor 1d turns off (YES, step S529a), the CPU 16a presses the lower roller pair 1b (step S529a) and returns the guide plate 10d1 and movable guide 10d2 to the home positions (step S530a).

Subsequently, as shown in FIG. 56B, when the trailing edge of the sheet stack moves away from the pass sensor 8a (YES, step S531), the CPU 16a causes the fold roller pair 3 and lower roller pair 12a to further rotate for a preselected period of time and then stop (step S532). The CPU 16a then turns off the pressure cancel motor 700 with the result that the swing arms 720a and 720b respectively press the fold rollers 3a and 3b under the action of the second spring 721 (step S532a). Further, the CPU 16a causes the belt 11d8 and jogger fence 11d6 to move to their stand-by positions. This is followed by the sequence of steps S535 through S539 stated previously.

As stated above, in the first modification, the pressure cancel motor 700 selectively cancels the pressure acting on the fold rollers 3a and 3b independently of the movement of the fold motor 2, so that the portions that press a sheet stack can be accurately controlled. The leading edge of a sheet stack is surely introduced into the nip between the fold rollers 3a and 3b by low pressure, then folded by high pressure, and then conveyed by low pressure, as stated in relation to the illustrative embodiment. The thicker the sheet stack, the longer the portion of the sheet stack to be folded in the direction of conveyance. In light of this, the range over which a sheet stack is to be folded should preferably be controlled in accordance with the thickness of a sheet stack, as will be described hereinafter.

In the first modification, the timing for driving the pressure cancel motor 700 is so set as to immediately cancel the pressure at preselected timing. It suffices to strongly press a sheet stack by 3 mm to 25 mm, particularly 3 mm to 10 mm, as measured from the leading edge of the sheet stack, as stated earlier. In light of this, when a sheet stack has moved over a pressing range set in accordance with its thickness, as counted by a timer, the CPU 16a turns on the pressure cancel motor 700. This allows the pressing range to be accurately set.

It is to be noted that a sheet stack should be strongly pressed at least over a range of 3 mm from the leading edge of the innermost sheet of the sheet stack. By so pressing a sheet stack, it is possible to surely, neatly folding the sheet stack.

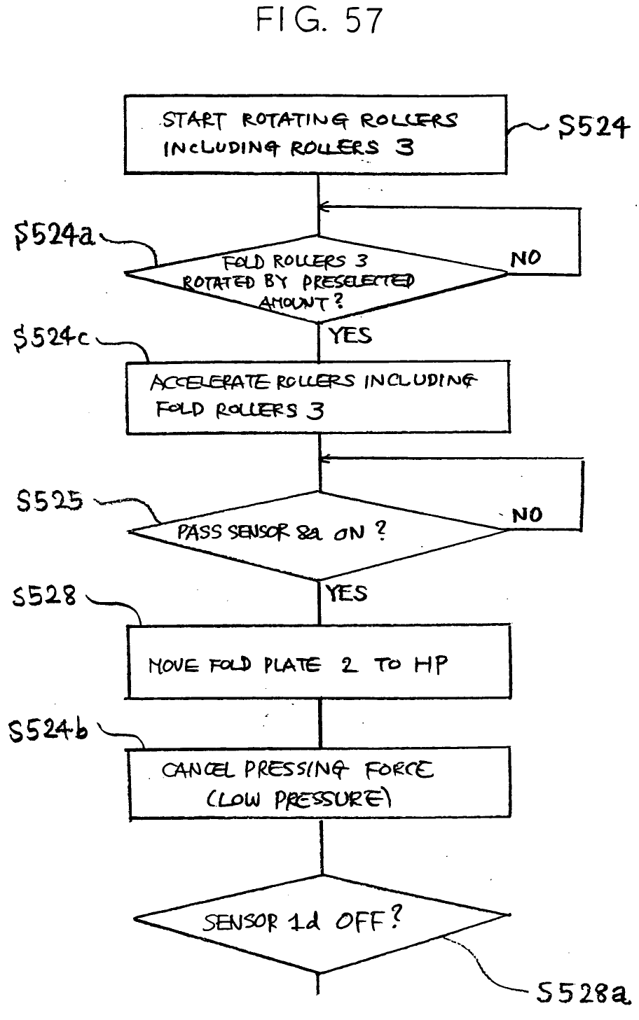

A second modification of the illustrative embodiment will be described with reference to FIG. 57. The second modification is identical with the first modification, FIG. 55, as to the fold roller pair 3 and the pressure applying and canceling mechanism and identical with the illustrative embodiment as to the rest of the configuration. The second modification takes account of the conveying time in order to effect efficient processing, compared to the first modification.

The second modification differs from the first modification as to the processing between the steps S524 and S528a shown in FIGS. 42 through 44, 54, 56A and 56B. More specifically, as shown in FIG. 57, assume that after the fold rollers 3a and 3b and lower outlet roller 12a have started rotating (step S524), the fold rollers 3a and 3b complete the folding operation (YES, step S524a). Then, the CPU 16a increase the rotation speed of the fold rollers 3a and 3b and that of the lower outlet roller 12a (step S524c). As soon as the leading edge of the sheet stack moves away from the pass sensor 8a (YES, step S525), the CPU 16a returns the fold plate 2 to the home position (step S528). As soon as the fold plate 2 leaves the leading edge of the sheet stack and the sheet stack is surely folded, the CPU 16a turns on the pressure cancel motor 700 for thereby retracting the pressure cancel link 770. As a result, the swing arms 720a and 720b are moved away from the fold rollers 3a and 3b (step S524b). This is followed by the step S528a and successive steps.

As stated above, the second modification folds a sheet stack at low speed in the same manner as in the illustrative embodiment and first modification, but accelerates the conveyance of the sheet stack as soon as the sheet stack is surely folded. This allows the sheet stack to be driven out to the lower tray 12b in a short period of time for thereby reducing the interval between consecutive jobs. For example, when the number of sheets constituting a sheet stack to be folded is relatively small, the first embodiment obviates or minimizes a waiting time otherwise necessary for a sheet stack to wait on the staple tray 10d.

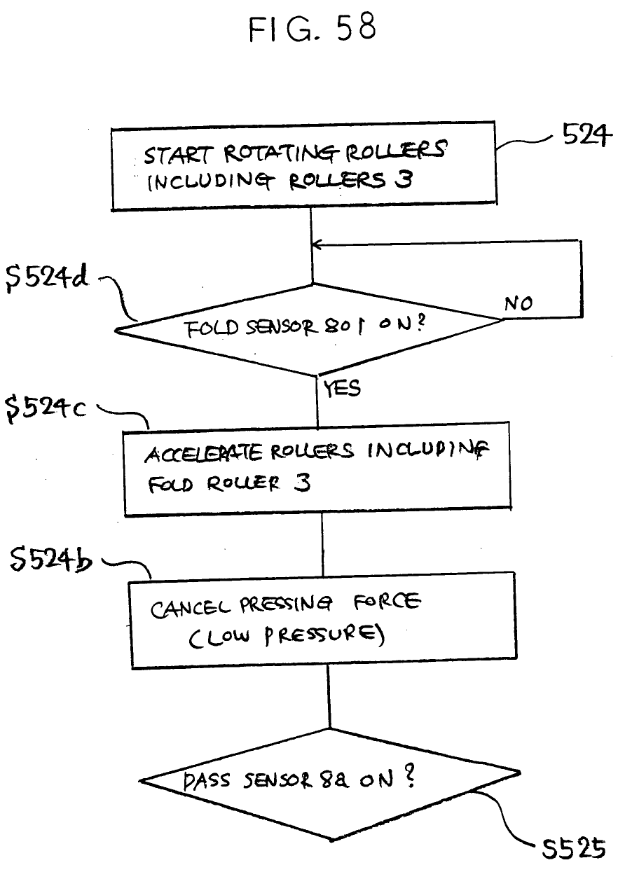

FIG. 58 shows a third modification of the illustrative embodiment. This third modification is identical with the first modification as to the fold roller pair 3 and pressure applying and canceling mechanism and identical with the illustrative embodiment as for the rest of the configuration. The third embodiment is capable of conveying a sheet stack at high speed in response to the output of a fold sensor 801 shown in FIG. 51, compared to the first modification. As shown in FIG. 51, the fold sensor 801 is responsive to the leading edge of a folded sheet or sheet stack. The timing for canceling the nip pressure between the fold rollers 3a and 3b is determined in accordance with the output of the fold sensor 801.

Regarding the folding procedure, the third embodiment differs from the first modification, FIGS. 42 through 44, 54, 56A, 56B and 57, as to the processing between the steps S524 and S525. As shown in FIG. 58, assume that the fold sensor 801, positioned just downstream of the nip between the fold rollers 3a and 3b, turns on by sensing the folded sheet stack moved away from the nip between the fold rollers 3a and 3b (YES, step S524d). Then, the CPU 16a increases the rotation speed of the fold rollers 3a and 3b and that of the lower fold roller pair 12a (step S524c). After the sheet stack has been surely folded, the CPU 16a turns on the pressure cancel motor 700 to thereby retract the pressure cancel link 770. As a result, the pressure of the swing arms 720a and 720b, acting on the fold rollers 3a and 3b, is canceled (step S524b). This is followed by the step S525 and successive steps.

As stated above, the third modification folds a sheet stack at low speed as in the illustrative embodiment and first modification, but accelerates the conveying speed as soon as the fold sensor 801 senses the leading edge of the folded sheet stack. This also allows the sheet stack to be driven out to the lower tray 12b in a short period of time for thereby reducing the interval between consecutive jobs. For example, when the number of sheets constituting a sheet stack to be folded is relatively small, the first embodiment obviates or minimizes a waiting time otherwise necessary for a sheet stack to wait on the staple tray 10d.

As stated above, the illustrative embodiment and modifications thereof are also capable of sharply, neatly folding a sheet stack while causing the folded position to accurately coincide with the stapled position.

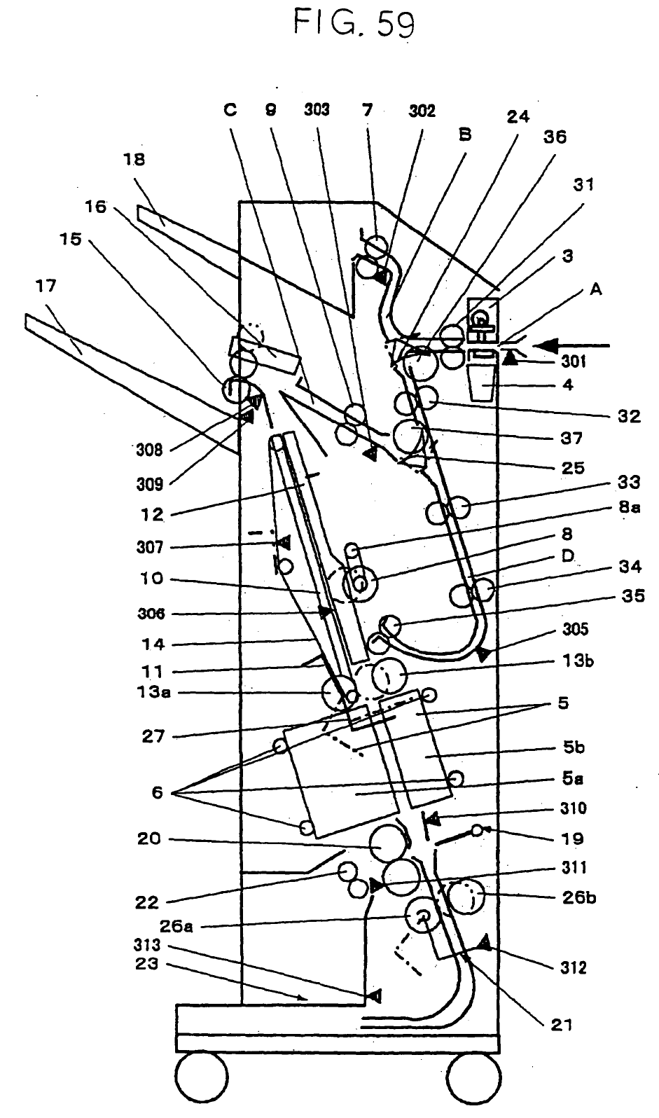

Various modifications will become possible for those skilled in the art after receiving the teachings of the present disclosure without departing from the scope thereof. For example, the present invention is similarly applicable to a sheet finisher shown in FIG. 59 of Japanese Patent Application assigned to the same assignee as the present application.

What is claimed is:

1. A sheet folding device for folding a sheet or a sheet stack conveyed thereto, said folding device comprising:
a path along which the sheet or the sheet stack to be folded is conveyed;
a fold plate movable in a direction perpendicular to said path for forming a fold in the sheet or the sheet stack;
a pair of first rotatable fold rollers facing said fold plate and positioned one above the other; and
pressing means for exerting, when the fold is to be formed, a pair of equal pressing forces on said pair of first fold rollers to thereby maintain a nip between said pair of first fold rollers on a line including a locus of movement of said fold plate.

2. The device as claimed in claim 1, wherein the sheet stack, stapled by stapling means, is conveyed along said path.

3. The device as claimed in claim 1, wherein the sheet stack, stapled at a center by a center stapler, is conveyed along said path.

4. The device as claimed in claim 1, wherein the sheet stack, stapled at an edge by an edge stapler, is conveyed along said path.

5. The device as claimed in claim 1, wherein said pair of first fold rollers stop rotating when a leading edge of the sheet or the sheet stack folded enters the nip between said first fold rollers.

6. The device as claimed in claim 5, wherein said pair of first fold rollers rotate, after stopping rotating, in opposite directions within a range that prevents a leading edge of the sheet or the sheet stack from moving out of the nip.

7. The device as claimed in claim 1, further comprising a pair of second fold rollers positioned downstream of said pair of first fold rollers in a direction of movement of said fold plate and positioned one above the other.

8. The device as claimed in claim 7, wherein said pair of first fold rollers and said pair of second fold rollers stop rotating when a leading edge of the sheet or sheet stack formed with the fold enters a nip between said pair of second fold rollers.

9. The device as claimed in claim 8, wherein said pair of first fold rollers and said pair of second fold rollers each rotate, after stopping rotating, in opposite directions within a range that prevents a leading edge of the sheet or the sheet stack from moving out of the nip.

10. The device as claimed in claim 1, wherein said pressing means comprises compression springs.

11. The device as claimed in claim 10, wherein said pressing means comprises upper pressing means and lower pressing means respectively pressing said pair of first fold rollers and said pair of second fold rollers.

12. The device as claimed in claim 11, wherein said upper pressing means and said lower pressing means have a same spring constant.

13. The device as claimed in claim 12, wherein said pressing means further comprises pressure adjusting means for adjusting pressing forces to act on said pair of first fold rollers.

14. The device as claimed in claim 13, wherein said pressure adjusting means varies a loaded length of the compression springs.

15. The device as claimed in claim 14, wherein said pressure adjusting means comprises an eccentric cam.

16. A sheet finisher for finishing a sheet or a sheet stack conveyed thereto and each carrying an image thereon, said sheet finisher comprising:
a path along which the sheet or the sheet to be finished is conveyed;
a sheet folding device configured to fold the sheet or the sheet stack conveyed along said path; and
sheet discharging means for discharging the sheet or the sheet stack folded by said folding device;
said sheet folding device comprising:
a path along which the sheet or the sheet stack to be folded is conveyed;
a fold plate movable in a direction perpendicular to said path for forming a fold in the sheet or the sheet stack;
a pair of first rotatable fold rollers facing said fold plate and positioned one above the other; and
pressing means for exerting, when the fold is to be formed, a pair of equal pressing forces on said pair of first fold rollers to thereby maintain a nip between said pair of first fold rollers on a line including a locus of movement of said fold plate.

17. An image forming apparatus comprising:
toner image forming means for forming a toner image on a sheet; and
a sheet folding device for folding the sheet or a sheet stack driven out of said toner image forming means and each carrying a toner image thereon;
said sheet folding device comprising:
a path along which the sheet or the sheet stack to be folded is conveyed;
a fold plate movable in a direction perpendicular to said path for forming a fold in the sheet or the sheet stack;
a pair of first rotatable fold rollers facing said fold plate and positioned one above the other; and
pressing means for exerting, when the fold is to be formed, a pair of equal pressing forces on said pair of first fold rollers to thereby maintain a nip between said pair of first fold rollers on a line including a locus of movement of said fold plate.

18. A sheet folding device for folding a sheet or a sheet stack, said sheet folding device comprising:
a pair of first fold rollers configured to form a fold in the sheet or the sheet stack;
a fold plate configured to contact the sheet or the sheet stack substantially perpendicularly to a surface of said sheet or said sheet stack for thereby pushing said sheet or said sheet stack into a nip between said pair of first fold rollers; and
first support means supporting said pair of first fold rollers such that said pair of first fold rollers have, when not folding the sheet or the sheet stack, the nip positioned on a locus of movement of said fold plate or an extension of said locus or are movable, when folding said sheet or said sheet stack, substantially symmetrically to each other with respect to said locus or said extension.

19. The device as claimed in claim 18, further comprising:
a pair of second fold rollers positioned downstream of said pair of first fold rollers in a direction of movement of said fold plate for reinforcing the fold formed by said pair of first fold rollers; and
second support means supporting said pair of second fold rollers such that said pair of second fold rollers have, when not folding the sheet or the sheet stack, a nip thereof positioned on a locus of movement of said fold plate or an extension of said locus or are movable, when folding said sheet or said sheet stack, substantially symmetrically to each other with respect to said locus or said extension.

20. The device as claimed in claim 19, wherein said path is configured such that the extension of the locus aligns with a center, in a direction of width, of a path following said pair of second fold rollers.

21. The device as claimed in claim 18, wherein said first support means comprises:
a movable shaft movable along the locus or the extension of said locus;
tie bars respectively connecting shafts of said pair of first fold rollers to said movable shaft; and
limiting members configured to limit a direction in which said shafts moves.

22. The device as claimed in claim 21, further comprising biasing means for constantly biasing said limiting members toward each other.

23. The device as claimed in claim 21, wherein said limiting members comprises a pair of movable members angularly movably supported by respective shafts and respectively supporting said roller shafts at preselected positions.

24. The device as claimed in claim 21, wherein said limiting members comprise:
a guide slot extending substantially perpendicularly to an extension of the direction of movement of said fold plate; and
a slide member slidably received in said guide slot and supporting said roller shafts.

25. The device as claimed in claim 21, further comprising displacement limiting means for limiting a displacement of said movable shaft.

26. The device as claimed in claim 18, wherein said path is configured such that the extension of the locus aligns with a center, in a direction of width, of a path following said pair of first fold rollers.

27. A sheet finisher comprising:
stapling means for stapling a sheet stack; and
a sheet folding device configured to fold the sheet stack stapled by said stapling means;
said sheet folding device comprising:
a pair of first fold rollers configured to form a fold in the sheet or the sheet stack;
a fold plate configured to contact the sheet or the sheet stack substantially perpendicularly to a surface of said sheet or said sheet stack for thereby pushing said sheet or said sheet stack into a nip between said pair of first fold rollers; and
first support means supporting said pair of first fold rollers such that said pair of first fold rollers have, when not folding the sheet or the sheet stack, the nip positioned on a locus of movement of said fold plate or an extension of said locus or are movable, when folding said sheet or said sheet stack, substantially symmetrically to each other with respect to said locus or said extension.

28. An image forming system comprising:
an image forming apparatus configured to form a toner image on a sheet; and
a sheet finisher constructed integrally with or operatively connected to said image forming apparatus for finishing the sheet carrying the toner image formed by said image forming apparatus;
said sheet finisher comprising:
stapling means for stapling a sheet stack; and
a sheet folding device configured to fold the sheet stack stapled by said stapling means;
said folding device comprising:
a pair of first fold rollers configured to form a fold in the sheet or the sheet stack;
a fold plate configured to contact the sheet or the sheet stack substantially perpendicularly to a surface of said sheet or said sheet stack for thereby pushing said sheet or said sheet stack into a nip between said pair of first fold rollers; and
first support means supporting said pair of first fold rollers such that said pair of first fold rollers have, when not folding the sheet or the sheet stack, the nip positioned on a locus of movement of said fold plate or an extension of said locus or are movable, when folding said sheet or said sheet stack, substantially symmetrically to each other with respect to said locus or said extension.

29. In a method of folding a sheet or a sheet stack by conveying said sheet or said sheet stack via a nip between a pair of rollers, a pressing force, acting on said sheet or said sheet stack, is varied in accordance with a condition in which said sheet or said sheet stack is conveyed.

30. The method as claimed in claim 29, wherein the pressing force is strong when a leading edge of the sheet or the sheet stack passes through the nip, but weak after said leading edge has moved away from said nip by a preselected distance.

31. The method as claimed in claim 30, wherein the pressing force, which is strong when the leading edge passes through the nip, is weak when said leading edge enters said nip.

32. A sheet folding device for folding a sheet or a sheet stack with a pair of rollers by conveying said sheet or said sheet stack via a nip between said pair of rollers, said folding device comprising:
pressing means for pressing said pair of fold rollers to thereby apply a pressing force for folding the sheet or the sheet stack; and
pressure varying means for varying the pressing force in accordance with a condition in which the sheet or the sheet stack is conveyed.

33. The device as claimed in claim 32, wherein said pressure varying means increases the pressing force when a leading edge of the sheet or the sheet stack passes through the nip between the pair of fold rollers.

34. The device as claimed in claim 33, wherein said pressure varying means decreases the pressing force after the leading edge of the sheet or the sheet stack has moved away from the nip between the pair of fold rollers.

35. The device as claimed in claim 33, wherein said pressure varying means increases the pressing force over a preselected range from the leading edge of the sheet or the sheet stack.

36. The device as claimed in claim 33, wherein said pressure varying means decreases the pressing force when the leading edge of the sheet or the sheet stack enters the nip between the pair of fold rollers.

37. The device as claimed in claim 32, wherein said pressure varying means increases the pressing force over a preselected range from a leading edge of an innermost sheet of the sheet stack folded.

38. The device as claimed in claim 32, wherein said pressing means comprises:
first elastic members positioned substantially symmetrically to each other with respect to a path along which the sheet or the sheet stack is conveyed for exerting relatively weak biasing forces;
first members configured to respectively transfer the biasing forces of said first elastic members to the pair of fold rollers;
a second elastic member configured to exert a relatively strong biasing force; and
second members configured to transfer the biasing force of said second elastic member to the pair of fold rollers;
wherein said pressure varying means varies the pressing force by switching the pressing force transferred via said first members and the pressing force transferred via said second members.

39. The device as claimed in claim 38, wherein said pressure varying means causes said first members to exert relatively weak pressing forces when a leading edge of the sheet stack enters the nip between the pair of fold rollers or causes said second members to exert relatively strong pressing forces when said leading edge passes through said nip.

40. The device as claimed in claim 38, wherein said first members each support one of the pair of fold rollers at one end thereof while said second members each press one of said first members to thereby exert a relatively strong pressing force on associated one of said pair of fold rollers.

41. The device as claimed in claim 40, wherein said pressing means further comprises a third member connecting said second members to each other and preventing said second members from pressing said first members when relatively weak pressing forces should be exerted.

42. The device as claimed in claim 41, further comprising a fold plate contacting a position where the sheet or the sheet stack should be folded at an edge thereof and pushing said sheet or said sheet stack into the nip between the pair of fold rollers, wherein said third member allows, when said fold plate pushes said sheet or said sheet stack into said nip, said second members to press said first members or prevents, when said fold plate is retracted from said nip to a preselected position, said second members from pressing said first members.

43. The device as claimed in claim 42, wherein said fold plate contacts, when being retracted, said third member and causes said third member to move in a direction of retraction of said fold plate, and said third member prevents, in interlocked relation to a movement of said fold plate, said second members from pressing said first members.

44. The device as claimed in claim 42, further comprising:
a drive mechanism including a motor for operating said third member; and
drive control means for controllably driving said motor;
wherein said drive control means turns on said motor at a preselected timing set independently of retraction of said fold plate to thereby cause said third member to prevent said second members from pressing said first members.

45. The device as claimed in claim 44, further comprising sensing means located at an outlet of the nip between the pair of fold rollers for sensing passage of the sheet or the sheet stack, wherein said preselected timing is set on the basis of an output of said sensing means representative of the passage of the sheet or the sheet stack.

46. A sheet folding device for folding a sheet or a sheet stack by causing a fold plate to contact a surface of said sheet or said sheet stack substantially perpendicularly to said surface and press said sheet or said sheet stack into a nip between a pair of fold rollers, said sheet folding device comprising:
a pair of first members respectively supporting the pair of fold rollers independently of each other;
support portions respectively supporting said pair of first members such that said pair of first members are angularly movable;
a pair of first elastic members respectively constantly biasing said pair of first members to thereby exert relatively weak pressing forces on the pair of fold rollers;
a pair of second members respectively angularly movably supported by said support portions and respectively pressing said pair of first members at intermediate portions thereof to thereby exert pressing forces on the pair of fold rollers;
a second elastic member constantly biasing said pair of second members toward each other to thereby exert relatively strong pressing forces on the pair of fold rollers;
a third member connecting said pair of second members to each other and controlling operations of said pair of second members for pressing said pair of first members; and
a pressing force control member configured to cause said third member to operate in accordance with a condition in which the sheet or the sheet stack is conveyed;
wherein said pair first members, said support portions, said pair of first elastic members, said pair of second members, said third elastic member and said third member are positioned substantially symmetrically with respect to a center of a path corresponding to a locus of movement of the fold plate.

47. The device as claimed in claim 46, wherein said third member is connected to said pair of second members at one end and connected to said pressing force control member at the other end, and
said pressing force control member moves, in interlocked relation to retraction of said fold plate, along a center of said path from a preselected position to an upstream side in a direction of sheet conveyance to thereby release said pair of second members from said pair of first members.

48. The device as claimed in claim 47, further comprising limiting means for limiting a movable range of the other end of said third member.

49. The device as claimed in claim 47, wherein a delay is provided for delaying an operation of each of said pair of second pressing members for pressing associated one of said pair of first members.

50. The device as claimed in claim 46, further comprising:
a drive mechanism including a motor for moving said pressing force control member; and
drive control means for controllably driving said motor;
wherein said third member is connected at one end to said pair of second members and connected to said pressing force control member at the other end,
said pressing force control member is movable along a center of said path by being driven by said drive mechanism,
said drive control means turns on said motor at a preselected timing set independently of retraction of the fold plate, and
said pressing force control member releases said pair of second members from said pair of first members when moved to an upstream side in a direction of sheet conveyance by said drive mechanism.

51. The device as claimed in claim 50, further comprising limiting means for limiting a movable range of the other end of said third member.

52. The device as claimed in claim 50, wherein a delay is provided for delaying an operation of each of said pair of second pressing members for pressing associated one of said pair of first members.

53. The device as claimed in claim 50, further comprising sensing means located at an outlet of the nip between the pair of fold rollers for sensing passage of the sheet or the sheet stack, wherein said preselected timing is set on the basis of an output of said sensing means representative of the passage of the sheet or the sheet stack.

54. A sheet finisher comprising:
stapling means for stapling a center of a sheet stack; and
a sheet folding device for folding the sheet stack stapled by said stapling means with a pair of rollers by conveying said sheet stack via a nip between said pair of rollers;
said sheet folding device comprising:
pressing means for pressing said pair of fold rollers to thereby apply a pressing force for folding the sheet stack; and
pressure varying means for varying the pressing force in accordance with a condition in which the sheet stack is conveyed.

55. A sheet finisher comprising:
stapling means for stapling a center of a sheet stack; and
a sheet folding device for folding the sheet stack stapled by said stapling means by causing a fold plate to contact a surface of said sheet stack substantially perpendicularly to said surface and press said sheet stack into a nip between a pair of fold rollers;
said folding device comprising:
a pair of first members respectively supporting the pair of fold rollers independently of each other;
support portions respectively supporting said pair of first members such that said pair of first members are angularly movable;
a pair of first elastic members respectively constantly biasing said pair of first members to thereby exert relatively weak pressing forces on the pair of fold rollers;
a pair of second members respectively angularly movably supported by said support portions and respectively pressing said pair of first members at intermediate portions thereof to thereby exert pressing forces on the pair of fold rollers;
a second elastic member constantly biasing said pair of second members toward each other to thereby exert relatively strong pressing forces on the pair of fold rollers;
a third member connecting said pair of second members to each other and controlling operations of said pair of second members for pressing said pair of first members; and
a pressing force control member configured to cause said third member to operate in accordance with a condition in which the sheet stack is conveyed;
wherein said pair first members, said support portions, said pair of first elastic members, said pair of second members, said third elastic member and said third member are positioned substantially symmetrically with respect to a center of a path corresponding to a locus of movement of the fold plate.

56. An image forming system comprising:
an image forming apparatus for forming a toner image on a sheet; and
a sheet finisher constructed integrally with or operatively connected to said image forming apparatus;
said sheet finisher comprising:
stapling means for stapling a center of a sheet stack; and
a sheet folding device for folding the sheet stack stapled by said stapling means with a pair of rollers by conveying said sheet stack via a nip between said pair of rollers;
said folding device comprising:
pressing means for pressing said pair of fold rollers to thereby apply a pressing force for folding the sheet stack; and
pressure varying means for varying the pressing force in accordance with a condition in which the sheet stack is conveyed.

57. An image forming system comprising:
an image forming apparatus for forming a toner image on a sheet; and
a sheet finisher constructed integrally with or operatively connected to said image forming apparatus;
said sheet finisher comprising:
stapling means for stapling a center of a sheet stack; and
a sheet folding device for folding the sheet stack stapled by said stapling means by causing a fold plate to contact a surface of said sheet stack substantially perpendicularly to said surface and press said sheet stack into a nip between a pair of fold rollers;
said folding device comprising:
a pair of first members respectively supporting the pair of fold rollers independently of each other;
support portions respectively supporting said pair of first members such that said pair of first members are angularly movable;
a pair of first elastic members respectively constantly biasing said pair of first members to thereby exert relatively weak pressing forces on the pair of fold rollers;
a pair of second members respectively angularly movably supported by said support portions and respectively pressing said pair of first members at intermediate portions thereof to thereby exert pressing forces on the pair of fold rollers;
a second elastic member constantly biasing said pair of second members toward each other to thereby exert relatively strong pressing forces on the pair of fold rollers;
a third member connecting said pair of second members to each other and controlling operations of said pair of second members for pressing said pair of first members; and
a pressing force control member configured to cause said third member to operate in accordance with a condition in which the sheet stack is conveyed;
wherein said pair first members, said support portions, said pair of first elastic members, said pair of second members, said third elastic member and said third member are positioned substantially symmetrically with respect to a center of a path corresponding to a locus of movement of the fold plate.
